(19) United States
(12) Patent Application Publication
(10) Pub. No.: US 2025/0334259 A1
(43) Pub. Date: Oct. 30, 2025

(54) WIRING TERMINAL, WIRING TERMINAL MODULE, LIGHT-EMITTING BODY, AND LAMP

(71) Applicant: JIANGMEN CITY SHENGDA LIGHTING CO., LTD., JIANGMEN (CN)

(72) Inventor: XIAOJUN XU, JIANGMEN (CN)

(21) Appl. No.: 19/260,379

(22) Filed: Jul. 4, 2025

Related U.S. Application Data
(63) Continuation-in-part of application No. 18/512,040, filed on Nov. 17, 2023, now Pat. No. 12,392,460.

(30) Foreign Application Priority Data
Oct. 23, 2023 (CN) 202311378975.3

(51) Int. Cl. F21V 23/06; F21S 4/26; F21S 9/03; F21V 17/06; F21V 17/08; F21V 23/00; F21Y 103/10; F21Y 105/16; F21Y 107/20; F21Y 107/30; H01R 24/58; H01R 103/00; H01R 105/00; H01R 107/00

(52) U.S. Cl. CPC F21V 23/06; F21S 4/26; F21S 9/032; F21S 9/037; F21V 17/06; F21V 17/08; F21V 23/002; H01R 24/58; F21Y 2103/10; F21Y 2105/16; F21Y 2107/20; F21Y 2107/30; H01R 2103/00; H01R 2105/00; H01R 2107/00

(57) ABSTRACT

A wiring terminal, a wiring terminal module, a light-emitting body, and a lamp are provided. The wiring terminal includes at least one terminal body and at least one power connecting port. An outer thread is disposed on an outer side surface of the at least one terminal body. The outer thread of the at least one terminal body is rotatable around a first axis and is configured to be screwed with an inner thread disposed om at least one opening of a lampshade of the lamp. The at least one power connecting port includes at least two electrical connectors. The at least two connectors of the at least one power connecting port are rotatable around a second axis. The second axis overlaps or is parallel to the first axis. The at least one terminal body and the at least one power connecting port are allowed to rotate together.

### TECHNICAL FIELD

The present disclosure relates to a technical field of lamps, and in particular to a wiring terminal, a wiring terminal module, a light-emitting body, and a lamp.

### BACKGROUND

Lamps in the prior art are not easy to assemble.

### SUMMARY

The present disclosure provides a wiring terminal for physically and electrically connecting a lamp, a wiring terminal module, a light-emitting body, and the lamp. When the wiring terminal is physically connected to a lampshade of the lamp, the wiring terminal realizes power connecting with an electrical component of the lamp, such as the light-emitting body.

### BRIEF DESCRIPTION OF DRAWINGS

FIG. 1 is a schematic diagram of a light body according to one embodiment of the present disclosure.

FIG. 2 is a schematic diagram of a light-emitting body connecting structure according to one embodiment of the present disclosure.

FIG. 3 is a schematic diagram of a lampshade according to one embodiment of the present disclosure.

FIG. 4 is a schematic diagram of a first embodiment of a light-emitting body according to one embodiment of the present disclosure.

FIG. 5 is a schematic diagram of a string light according to one embodiment of the present disclosure.

FIG. 6 is a schematic diagram showing an assembling method of the light body through light-emitting body connecting structures according to one embodiment of the present disclosure.

FIG. 7A is a schematic diagram of a first embodiment of a wiring terminal according to one embodiment of the present disclosure.

FIG. 7B is another schematic diagram of the first embodiment of the wiring terminal according to one embodiment of the present disclosure.

FIG. 8A is a schematic diagram of a second embodiment of the wiring terminal according to one embodiment of the present disclosure.

FIG. 8B is another schematic diagram of the second embodiment of the wiring terminal according to one embodiment of the present disclosure.

FIG. 9A is a schematic diagram of a third embodiment of the wiring terminal according to one embodiment of the present disclosure.

FIG. 9B is another schematic diagram of the third embodiment of the wiring terminal according to one embodiment of the present disclosure.

FIG. 9C is a perspective schematic diagram of a terminal body of the third embodiment of the wiring terminal according to one embodiment of the present disclosure.

FIG. 10 is a schematic diagram of a fourth embodiment of the wiring terminal according to one embodiment of the present disclosure.

FIG. 11A is a schematic diagram of a fifth embodiment of the wiring terminal according to one embodiment of the present disclosure.

FIG. 11B is another schematic diagram of the fifth embodiment of the wiring terminal according to one embodiment of the present disclosure.

FIG. 12A is a schematic diagram of a sixth embodiment of the wiring terminal according to one embodiment of the present disclosure.

FIG. 12B is another schematic diagram of the sixth embodiment of the wiring terminal according to one embodiment of the present disclosure.

FIG. 13 is a schematic diagram of a seventh embodiment of the wiring terminal according to one embodiment of the present disclosure.

FIG. 14 is a schematic diagram of an eighth embodiment of the wiring terminal according to one embodiment of the present disclosure.

FIG. 15A is a schematic diagram of a ninth embodiment of the wiring terminal according to one embodiment of the present disclosure.

FIG. 15B is another schematic diagram of the ninth embodiment of the wiring terminal according to one embodiment of the present disclosure.

FIG. 16A is a schematic diagram of a first embodiment of a power connecting port according to one embodiment of the present disclosure.

FIG. 16B is another schematic diagram of the first embodiment of the power connecting port according to one embodiment of the present disclosure.

FIG. 17A is a schematic diagram of a second embodiment of the power connecting port according to one embodiment of the present disclosure.

FIG. 17B is another schematic diagram of the second embodiment of the power connecting port according to one embodiment of the present disclosure.

FIG. 18A is a schematic diagram of a third embodiment of the power connecting port according to one embodiment of the present disclosure.

FIG. 18B is another schematic diagram of the third embodiment of the power connecting port according to one embodiment of the present disclosure.

FIG. 19A is a schematic diagram of a fourth embodiment of the power connecting port according to one embodiment of the present disclosure.

FIG. 19B is another schematic diagram of the fourth embodiment of the power connecting port according to one embodiment of the present disclosure.

FIG. 20A is a schematic diagram of a fifth embodiment of the power connecting port according to one embodiment of the present disclosure.

FIG. 20B is another schematic diagram of the fifth embodiment of the power connecting port according to one embodiment of the present disclosure.

FIG. 21A is a schematic diagram of a sixth embodiment of the power connecting port according to one embodiment of the present disclosure.

FIG. 21B is another schematic diagram of the sixth embodiment of the power connecting port according to one embodiment of the present disclosure.

FIG. 22A is a schematic diagram of a seventh embodiment of the power connecting port according to one embodiment of the present disclosure.

FIG. 22B is another schematic diagram of the seventh embodiment of the power connecting port according to one embodiment of the present disclosure.

FIG. 23 is a schematic diagram of a second embodiment of the light-emitting body according to one embodiment of the present disclosure.

FIG. 24A is a schematic diagram of a third embodiment of the light-emitting body according to one embodiment of the present disclosure.

FIG. 24B is another schematic diagram of the third embodiment of the light-emitting body according to one embodiment of the present disclosure.

FIG. 24C is another schematic diagram of the third embodiment of the light-emitting body according to one embodiment of the present disclosure.

FIG. 25 is a schematic diagram of a fourth embodiment of the light-emitting body according to one embodiment of the present disclosure.

FIG. 26 is a schematic diagram of a fifth embodiment of the light-emitting body according to one embodiment of the present disclosure.

FIG. 27 is a schematic diagram of a first embodiment of a lamp according to one embodiment of the present disclosure.

FIG. 28 is a schematic diagram of a second embodiment of the lamp according to one embodiment of the present disclosure.

FIG. 29 is a schematic diagram of a third embodiment of the lamp according to one embodiment of the present disclosure.

FIG. 30 is a schematic diagram of a fourth embodiment of the lamp according to one embodiment of the present disclosure.

FIG. 31 is a schematic diagram of a fifth embodiment of the lamp according to one embodiment of the present disclosure.

FIG. 32 is a schematic diagram of a sixth embodiment of the lamp according to one embodiment of the present disclosure.

FIG. 33 is a schematic diagram of a seventh embodiment of the lamp according to one embodiment of the present disclosure.

FIG. 34 is a schematic diagram of an eighth embodiment of the lamp according to one embodiment of the present disclosure.

FIG. 35A is a schematic diagram of a ninth embodiment of the lamp according to one embodiment of the present disclosure.

FIG. 35B is another schematic diagram of the ninth embodiment of the lamp according to one embodiment of the present disclosure.

FIG. 36 is a schematic diagram of a first embodiment of a lampshade according to one embodiment of the present disclosure.

FIG. 37 is a schematic diagram of a second embodiment of the lampshade according to one embodiment of the present disclosure.

FIG. 38A is a schematic diagram of a tenth embodiment of the lamp according to one embodiment of the present disclosure.

FIG. 38B is another schematic diagram of the tenth embodiment of the lamp according to one embodiment of the present disclosure.

FIG. 39A is a schematic diagram of a first embodiment of an assembly process of the lamp according to one embodiment of the present disclosure.

FIG. 39B is another schematic diagram of the first embodiment of the assembly process of the lamp according to one embodiment of the present disclosure.

FIG. 39C is another schematic diagram of the first embodiment of the assembly process of the lamp according to one embodiment of the present disclosure.

FIG. 39D is another schematic diagram of the first embodiment of the assembly process of the lamp according to one embodiment of the present disclosure.

FIG. 40A is a schematic diagram of a second embodiment of an assembly process of the lamp according to one embodiment of the present disclosure.

FIG. 40B is another schematic diagram of the second embodiment of the assembly process of the lamp according to one embodiment of the present disclosure.

FIG. 40C is another schematic diagram of the second embodiment of the assembly process of the lamp according to one embodiment of the present disclosure.

FIG. 41A is a schematic diagram of a third embodiment of an assembly process of the lamp according to one embodiment of the present disclosure.

FIG. 41B is another schematic diagram of the third embodiment of the assembly process of the lamp according to one embodiment of the present disclosure.

FIG. 41C is another schematic diagram of the third embodiment of the assembly process of the lamp according to one embodiment of the present disclosure.

In the drawings:

1-wiring terminal, 11-terminal body, 111-outer thread, 112-annular limiting piece, 12-power connecting port, 13-wire rod, 14-handle piece; 2-lampshade, 21-lampshade main body, 22-opening; 3-light body, 31-light-emitting body 311-lightstrip, 312-support, 313-circuit board, 32-power connecting plug; 321-wiring input terminal plug, 322-wiring output terminal plug; 4-wire, 41-hanging piece.

10A-10J-lamp; 11G-lamp string; 100, 100A-100I-wiring terminal; 110-terminal body; 111-outer thread; 112-outer side surface; 113-first end surface; 114-second end surface; 115-sealing structure; 116-reveiving groove; 117-driving structure; 110A-first terminal body; 111A-first outer thread; 112A-first outer side surface; 110B-second terminal body; 111B-second outer thread; 112B-second outer side; 113A-first end surface; 113B-first end surface; 110C-first terminal body; 110D-second terminal body; 111C-first outer thread; 111D-second outer thread; 120-power connecting port; 121-electrical connector; 122-insulating piece; 1221-opening; 1222-accommodating cavity; 123-carrier; 1231-outer thread; 120A-first power connecting port; 121A-electrical connector; 120B-second power connecting port; 121B-electrical connector; 120a-120g-power connecting port; 121a-first electrical connector; 121b-second electrical connector; 121c-third electrical connector; 121d-fourth electrical connector; 1211-first electrical connection part; 1212-second electrical connection part; 1213-third electrical connection part; 1214-fourth electrical connection part; 130-wire; 131-wire protective sleeve; 140-connector; 141-outer thread; 150-protective cover; 200-light-emitting body; 200A-200D light-emitting body;

210-power connecting plug; 211-electrical connector; 220-rigid circuit board; 230-light-emitting element; 240-flexible circuit board; 250-support; 260-outer sleeve; 261-first sleeve; 262-second sleeve; 263-through hole; 210A-first power connecting plug; 211A-electrical connector; 210B-second power connecting plug; 211B-electrical connector; 210C-first power connecting plug; 210D-Second power plug;

300-lampshade; 300A-lampshade; 300B-lampshade; 310-first opening; 320-second opening; 330-accommodating cavity; 340-first inner thread; 350-second inner thread; 360-waterproof groove; 370-mounting groove;

400-solar panel;

510-base; 520-support rod; 530-mounting component; 540-wire;

101-first assembling body; 102-second assembling body; 103-third assembling body; 201-first assembling body; 202-second assembling body; 203-third assembling body; 2011-gap; L1-first axis; L2-second axis; L3-third axis; L4-fourth axis; L5-fifth axis; L6-sixth axis; F1-first direction; F2-second direction.

### DETAILED DESCRIPTION

The embodiment is intended to solve problems of difficulty in adjusting and aligning conventional terminals to install a light-emitting body thereof, high assembly difficulty, and low work efficiency.

In two light-emitting body connecting structures of the present disclosure, each of power connecting ports protrudes from an end surface of a first end of a corresponding terminal body of terminal bodies. When assembling, a first light-emitting body connecting structure is plugged into a first end of a light-emitting body, and the light-emitting body is inserted into a first opening of a lampshade, then the first light-emitting body connecting structure is connected to the first opening of the lampshade.

A second light-emitting body connecting structure is inserted into a second opening of the lampshade. Because the light-emitting body is accommodated in the lampshade, and lengths of the light-emitting body connecting structures connecting the light-emitting body are adapted to a mounting length of the lampshade, when a second end of the light-emitting body moves towards the second opening of the lampshade, a power connecting port of the second light-emitting body connecting structure is inserted into the second opening of the lampshade. A size of each of the power connecting ports is less than a size of each of the openings of the lampshade, so that the power connecting port of the second light-emitting body connecting structure is movable in the second opening to adjust a position, so as to align with a corresponding power connecting plug disposed on the second end of the light-emitting body. When the second light-emitting body connecting structure is connected to the second opening of the lampshade, the power connecting port of the second light-emitting body connecting structure is completely plugged into the second end of the light-emitting body, effectively realizing that the light-emitting body is installed in the lampshade and aligned with the two openings of the lampshade through the two light-emitting body connecting structures, which improves assembly efficiency.

As shown in FIGS. 1-6, the present disclosure provides a light body. The light body comprises a lampshade 2, two light-emitting body connecting structures, and a light-emitting body 31. An accommodating cavity is defined in the lampshade 2. Openings 22 communicated with the accommodating cavity are defined on the lampshade 2. The openings 22 comprise a wiring input terminal opening and a wiring output terminal opening.

The two light-emitting body connecting structures comprise wiring terminals 1. The wiring terminals 1 comprise terminal bodies 11 matched with the openings 22 and power connecting ports 12. The terminal bodies 11 are respectively detachably connected to the openings 22. Each of the power connecting ports 12 protrudes from an end surface of a first end of a corresponding terminal body 11 of the terminal bodies 11. A size of each of the power connecting ports 12 is less than a size of each of the openings 22 of the lampshade 2. Each of the power connecting ports 12 is insertable into the lampshade 2 from a corresponding opening of the openings 22 to align and connect with the light-emitting body 31.

The light-emitting body 31 is detachably disposed in the accommodating cavity of the lampshade 2. Power connecting plugs 32 are disposed on two ends of the light-emitting body 31. When the light-emitting body 31 is disposed in the accommodating cavity, the light-emitting body 31 is connected to the openings 22 of the lampshade 2 through the two light-emitting body connecting structures, and the power connecting plugs 32 disposed on the two ends of the light-emitting body 31 are respectively plugged into the power connecting ports 12 of the two light-emitting body connecting structures.

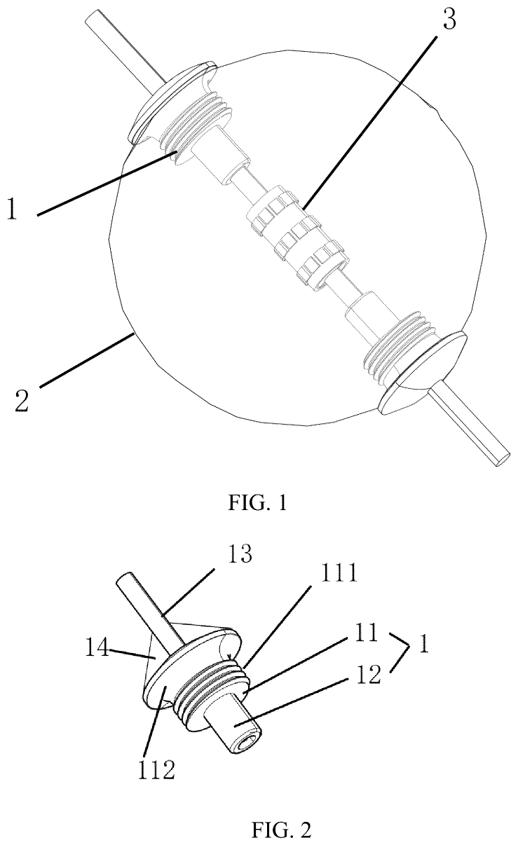

Specifically, as shown in FIG. 2, an outer thread 111 is defined on an outer side of each of the terminal bodies 11. An inner thread is defined on each of the openings 22. The outer thread 111 is matched with the inner thread. The power connecting ports 12 comprise rotatable plugs configured to plug into the light-emitting body 31.

It should be noted that each of the rotatable plugs may comprise a male plug and a female plug matched with the male plug. Each of the rotatable plugs may be a headphone plug, a direct current (DC) plug, an audio plug, and other plugs having a cylindrical connector to support, fix, and electrically connect to the light-emitting body. 31. During a plugging process, the male plug or the female plug of each of the rotatable plugs are rotated arbitrarily while maintaining power connecting with the female plug thereof of the male plug thereof.

Specifically, as shown in FIG. 2, the light body comprises wire rods 13. Each of the wire rods 13 passes through a second end of a corresponding terminal body 11 of the terminal bodies 11 and is electrically connected to a corresponding power connecting port 12 of the power connecting ports 12.

Specifically, an annular limiting piece 112 is disposed on an end surface of the second end of each of the terminal bodies 11. It should be noted that each annular limiting piece 112 is configured to abut against an outer side of a corresponding opening 22 to prevent a corresponding terminal body of the terminal bodies 11 from being excessively screwed into the corresponding opening 22 of the lampshade 2.

It should be added that the lampshade 2 defines grooves each matched with each annular limiting piece 112, so that each annular limiting piece 112 is embedded in a corresponding groove of the grooves. A surface of each annular limiting piece 112 is flush with a surface of the lampshade 2, maintaining the beauty of the light body.

It should be noted that each of the wire rods 13 passes through the second end of the corresponding terminal body 11 of the terminal bodies 11 and is electrically connected to the corresponding power connecting port 12 of the power connecting ports 12. Each of the power connecting ports 12 protruding from the end surface of the first end of the corresponding terminal body 11 of the terminal bodies 11 is insertable into the lampshade 2, and each of the wire rods 13 is connected to a corresponding wire or a transformer.

As shown in FIG. 2, to facilitate each of the terminal bodies 11 to be screwed into or out of the corresponding opening 22 of the lampshade 2, one handle piece 14 disposed on one side of an end portion of each of the wire rods 13 is connected to a second end of each of the terminal bodies 11, or a plurality of handle pieces 14 respectively disposed on two sides of the end portion of each of the wire rods 13 are connected to a second end of each of the terminal bodies 11.

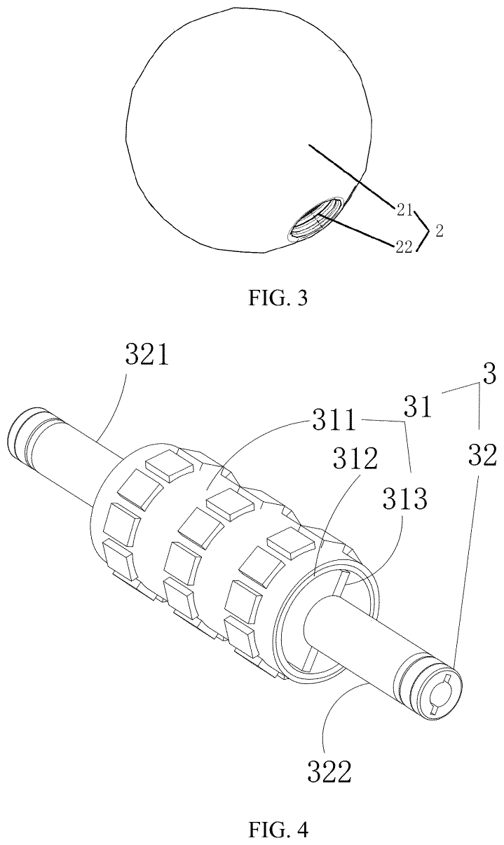

In one optional embodiment, as shown in FIG. 3, when each annular limiting piece 112 is disposed on the end surface of the second end of each of the terminal bodies 11, the one or the plurality of handle pieces 14 disposed on the end portion of each of the wire rods 13 may be connected to a corresponding annular limiting piece 112.

The one or the plurality of handle pieces 14 disposed on the end portion of each of the wire rods 13 are connected to the corresponding terminal body of the terminal bodies 11, by holding the one or the plurality of handle pieces 14 of each of the wire rods 13 to rotate, the terminal bodies 11 are respectively screwed with the openings 22 of the lampshade 2, which provides a stress point, avoiding that it is difficult to rotate the terminal bodies 11 by round wires. The light-emitting body connecting structures comprise the rotatable plugs insertable into the light-emitting body 31. When each of the power connecting ports 12 is aligned with the corresponding power connecting plug of the light-emitting body 31, by screwing each of the power connecting ports 12 into the corresponding terminal body 11 along the inner thread of each of the openings 22, the light-emitting body connecting structures are plugged into the light-emitting body 31. In particular, the one or the plurality of handle pieces 14 of each of the terminal bodies 11 are also configured as reinforcing pieces reinforcing connection between each of the wire rods 13 and the corresponding terminal body 11 to prevent fractures at a joint and improve service life of the wire rods 13 and the terminal bodies 11.

In addition, as shown in FIG. 4, the lampshade 2 comprises a lampshade main body 21 that is nonopaque, the accommodating cavity is defined inside the lampshade main body 21, and the openings 22 of the lampshade 2 comprise the wiring input terminal opening and the wiring output terminal opening.

The lampshade 2 in the embodiment is an integrally formed circular lampshade 2. In other embodiments, the lampshade 2 has a square or cylindrical shape, which is selected according to specific circumstances.

It should be added that the wiring input terminal opening and the wiring output terminal opening defined on the lampshade 2 of the embodiment are symmetrically or asymmetrically disposed, but an axis direction of the wiring input terminal opening and an axis direction of the wiring output terminal opening are respectively corresponding to the power connecting plugs 32 of the light-emitting body 31.

Specifically, as shown in FIG. 4, the power connecting plugs 32 comprise a wiring input terminal plug 321 and a wiring output terminal plug 322. The wiring input terminal plug 321 and the wiring output terminal plug 322 are respectively disposed on the two ends of the light-emitting body 31. A power supply input terminal of the light-emitting body 31 is electrically connected to the wiring input terminal. A power supply output terminal of the light-emitting body 31 is electrically connected to the wiring output terminal plug 322.

As shown in FIG. 4, to improve uniformity of light emitted by the light-emitting body 31 in the lampshade 2, the light-emitting body 31 comprises: a light strip 311 and a support 312. The light strip 311 wraps an outer side of the support 312. It should be noted that the light strip 311 comprises bulbs or LED lights that are locally provided, and has a strip body made from a soft and flexible material, such as a rubber sleeve or plastic. The light strip 311 has a self-adhesive backing that is easily attached to the support 312.

Specifically, as shown in FIG. 4, the light body further comprises a circuit board 313. The support 312 is hollow and the circuit board 313 is disposed inside the support 312. The circuit board 313 is electrically connected to the light strip 311. The wiring input terminal plug 321 and the wiring output terminal plug 322 are respectively fixedly disposed on two ends of the circuit board 313. An input terminal of the circuit board 313 is electrically connected to the wiring input terminal plug 321, and an output terminal of the circuit board 313 is electrically connected to the wiring output terminal plug 322. It should be noted that the support 312 in the embodiment is in a cylinder that is hollow. The light strip 311 is wrapped on an outer side of the cylinder, and the circuit board 313 is placed in the cylinder. In some embodiments, two ends of the support 312 are fixedly connected to the wiring input terminal plug 321 and the wiring output terminal plug 322 respectively, which also provide effective support.

It should be noted that the light-emitting body in the embodiment may also be a light bar, and two ends of the light bar are fixedly and electrically connected to the wiring input terminal plug 321 and the wiring output terminal plug 322.

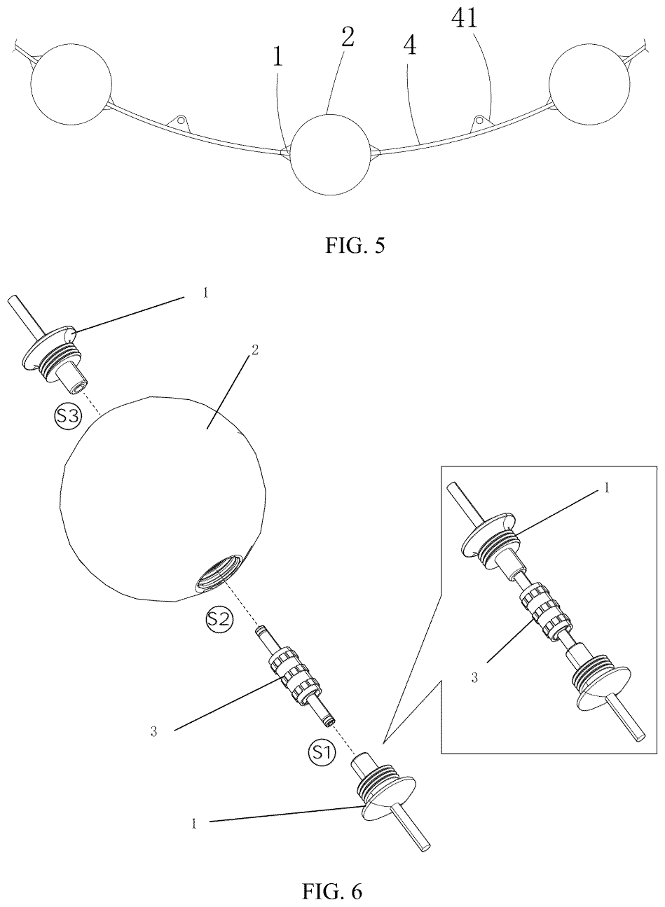

As shown in FIG. 5, the present disclosure further provides a string light. The string light comprises a plurality of light bodies 3 mentioned above and a plurality of wires. The plurality of light bodies 3 comprise a plurality of lampshades 2.

Each of the light-emitting body connecting structures of each of the plurality of light bodies 3 are electrically connected to a corresponding light-emitting body connecting structure of an adjacent light body 3 through a corresponding wire, so that the plurality of lampshades 2 are connected in series through the plurality of wires.

It should be noted that each of the wire rods 13 of each of the light-emitting body connecting structures is extended and connected to another light-emitting body connecting structure of the adjacent light body 3, and the wire rods 13 can also be served as the plurality of wires 4 mentioned above.

Specifically, as shown in FIG. 4, hanging pieces 41 are hung on the plurality of wires 4. The hanging pieces 41 may be rings, which enable the string light to be hung on suitable hooks for decoration.

The present disclosure further provides an assembling method of the string light to achieve quick assembly of the string light. The assembling method comprises steps S1-S4.

The step S1 comprises plugging a first light-emitting body connecting structure of one of a plurality of wires into a first end of one of a plurality of light-emitting bodies 31.

The step S2 comprises inserting the one of the plurality of light-emitting bodies 31 into one of a plurality of lampshades 2 from a first opening 22 of the one of the plurality of lampshades 2; and connecting the first light-emitting body connecting structure to the first opening 22 of the one of the plurality of lampshades 2.

The step S3 comprises inserting a power connecting port 12 of a second light-emitting body connecting structure of another one of the plurality of wires into the one of the plurality of lampshades 2 from a second opening 22 of the one of the plurality of lampshades 2; aligning the power connecting port 12 of the second light-emitting body connecting structure to abut against a second end of the one of the plurality of light-emitting bodies 31; and connecting the second light-emitting body connecting structure to the second opening 22 of the one of the plurality of lampshades 2 to enable the power connecting port 12 of the second light-emitting body connecting structure being completely plugged into the second end of the one of the plurality of light-emitting bodies 31.

The step S4 comprises sequentially assembling other light bodies to the plurality of wires according to steps S1, S2 and S3 to complete assembly of the string light.

It should be noted that in the assembling method of the embodiment, the light-emitting body connecting structures are connected to the openings 22 of the plurality of lampshades 2 through threaded connection. In other embodiments, the light-emitting body connecting structures are connected to the openings 22 of the plurality of lampshades 2 through snap/clamping connection. It is understood that through the threaded connection, the connection joint is firmly fixed and not easy to fall off, and even if the string light is placed outdoors, the threaded connection brings excellent sealing performance and good waterproof effect, which well protect the plurality of light bodies.

In the step S3, the second light-emitting body connection structure is connected to the second opening 22 of one of the plurality of lampshades 2, and at the same time, the power connecting port 12 of the second light-emitting body connecting structure is completely plugged into the second end of the one of the plurality of light-emitting bodies 31. It should be noted that: the power connecting port 12 of the second light-emitting body connecting structure is first aligned with and abuts against the second end of the one of the plurality of light-emitting bodies 31. Then, the second light-emitting body connection structure is screwed with the second opening 22 of one of the plurality of lampshades 2. A screwing process thereof is a process of plugging the power connecting port 12 of the second light-emitting body connecting structure into the second end of the one of the plurality of light-emitting bodies31. When the second light-emitting body connection structure is completely screwed with the second opening 22 of one of the plurality of lampshades 2, the power connecting port 12 of the second light-emitting body connecting structure is completely plugged into the second end of the one of the plurality of light-emitting bodies31.

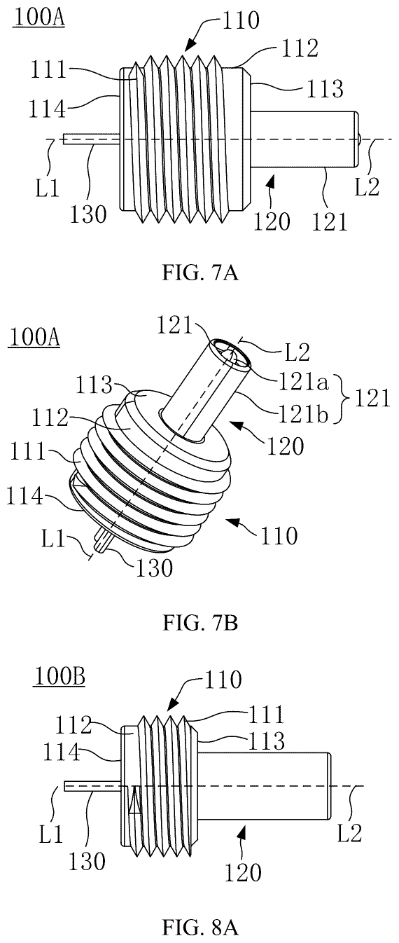

As shown in FIGS. 7A-15B, the present disclosure provides a wiring terminal (100A-100I) for physically and electrically connected to a lamp. The wiring terminal (100A-100I) is applied to the lamp, that is, the lamp comprises the wiring terminal (100A-100I). It is understood that the lamp comprises other components except for the wiring terminal (100A-100I) and the lamp may comprise one or more wiring terminals. As shown in FIGS. 27-32 and FIGS. 35A and 35B, the lamp (10A, 10B, 10C, 10D, 10E, 10F, 10G, 10I, 10J) further comprises at least one light-emitting body 200 and at least one lampshade 300. The light-emitting body 200 is also called a light-emitting component. After each light-emitting body 200 is electrically connected to a corresponding wiring terminal 100, the corresponding wiring terminal 100 is capable of supplying power to each light-emitting body 200 through a battery or a mains supply, so that each light-emitting body 200 is capable of emitting light. Light emitted by each light-emitting body 200 is transmitted to the outside of a corresponding lampshade 300 through the corresponding lampshade 300. It should be noted that the wiring terminal 100 may be electrically connected to another electrical component of the lamp (10A-10J). For instance, the wiring terminal 100 is electrically connected to a solar panel 400 of the lamp (10A-10J).

In one case, the electrical component of the lamp (10A-10J) may comprise at least one light-emitting body 200 of the lamp (10A-10J). In another case, the electrical component of the lamp (10A-10J) may comprise a solar panel 400 of the lamp (10A-10J). Alternatively, the electrical component of the lamp (10A-10J) may comprise both the at least one light-emitting body 200 of the lamp (10A-10J) and the solar panel 400 of the lamp (10A-10J). Alternatively, the electrical component of the lamp (10A-10J) may further comprise other electrical structures of the lamp. The electrical component of the lamp (10A-10J) of the present disclosure is not limited to the at least one light-emitting body 200 and the solar panel 400, which are not depicted in detail hereby.

Some embodiments of the wiring terminal are described in detail first, and embodiments of the lamp are described in detail later in conjunction with the drawings.

As shown in FIGS. 7A-15B, the wiring terminal (100A-100I) comprises at least one terminal body 110 and at least one power connecting port 120. The at least one power connecting port 120 is one-to-one physically connected to the at least one terminal body 110. Each terminal body 110 is served as a carrier of a corresponding power connecting port 120. Each terminal body 110 is further configured to be connected to an inner thread (such as a first inner thread 340) of a lampshade 300 of the lamp (10A-10J). As shown in FIGS. 7A-15B, the wiring terminal (100A-100F, 100I) comprises one terminal body 110 and one power connecting port 120. The following embodiments describe the wiring terminal (100A-F, 100I) including only one terminal body 110 and one power connecting port 120 first, and then describe embodiments where the wiring terminal 100 comprises terminal bodies 110 and power connecting ports 120. In other words, the wiring terminal 100 comprises at least two terminal bodies 110 and at least two power connecting ports 120.

The terminal body 110 comprises a first end surface 113, a second end surface 114 and an outer side surface 112. The outer side surface 112 of the terminal body 110 connects the first end surface 113 to the second end surface 114. An outer thread 111 is disposed on the outer side surface 112 of the terminal body 110. The outer thread 111 of the terminal body 110 is configured to connect with the inner thread (a first inner thread 340 or a second inner thread 350 of the lampshade 300) disposed on an opening (a first opening 310 or a second opening 320) of the lampshade 300 of the lamp (10A-10J). That is, each inner thread of the lampshade is disposed on a corresponding opening of the lampshade 300.

The wiring terminal (100A-100F, 100I) is electrically connected to the electrical component of the lamp (10A-10J), such as the light-emitting body 200. In the embodiment of the present disclosure, during a connection process of the outer thread 111 of the terminal body 110 and the inner thread (such as the first inner thread 340) of the lampshade 300, the power connecting port 120 is plugged into the light-emitting body 200, and the power connecting port 120 and the light-emitting body 200 mutually rotate, rotate relative to each other, or rotate together. Specifically, the terminal body 110 and the power connecting port 120 are rotatable together. For example, the terminal body 110 drives the power connecting port 120 to rotate synchronously. Alternatively, the terminal body 110 rotates under an action of a driving force and is connected to the lampshade 300, and then drives the power connecting port 120 to rotate together. In an initial stage of the connection process of the outer thread 111 of the terminal body 110 and the inner thread (such as the first inner thread 340) of the lampshade 300, the power connecting port 120 and the electrical component (such as the light-emitting body 200) of the lamp (10A-10J) are in an initial mutual plug-in stage. As the terminal body 110 rotates, a connecting area between the outer thread 111 of the terminal body 110 and the first inner thread 340 of the lampshade 300 gradually increases, and plug-in portions of the power connecting port 120 and the electrical component (such as the light-emitting body 200) of the lamp (10A-10J) gradually increase.

After the connection process of the outer thread 111 of the terminal body 110 and the first inner thread 340 of the lampshade 300 is completed, the power connecting port 120 and the light emitter 200 are electrically connected. Therefore, the wiring terminal 100 (100A-100F, 100I) simultaneously achieves physical and power connecting with at least the lampshade 300 and the light-emitting body 200 of the lamp (10A-10J). Compared with a scheme in the prior art where the power connecting port is only connected to the electrical component of the lamp and a scheme in the prior art where the lampshade is only connected to the lamp rod, the embodiment of the present disclosure achieves the physical and power connecting of the lamp in the connection process of the terminal body and the lampshade 300, thereby simplifying an assembling process and facilitating mounting for the user.

The power connecting port 120 and the electrical component (such as the light-emitting body 200) of the lamp (10A-10J) rotate together, which means that the power connecting port 120 and the electrical component of the lamp (10A-10J) rotate synchronously together and in the same direction.

The power connecting port 120 and the electrical component (such as the light-emitting body 200) of the lamp (10A-10J), are rotatable relative to each other, which means that the electrical component of the lamp (10A-10J) is able to rotate while the power connecting port 120 is in a stationary state relative to the electrical component of the lamp (10A-10J), or the power connecting port 120 is able to rotate while the electrical component of the lamp (10A-10J) is in a stationary state relative to the power connecting port 120.

The power connecting port 120 and the electrical component (such as the light-emitting body 200) of the lamp (10A-10J) mutually rotate, which means that both of the power connecting port 120 and the electrical component of the lamp (10A-10J) rotate, but the two are rotates in different directions. It should be understood that the meaning of “rotate together” is different from the meaning of “mutually rotate”.

The power connecting port 120 is plugged with the electrical component (such as the light-emitting body 200) of the lamp (10A-10J), which means that a first portion of the power connecting port 120 is plugged into a first portion of the electrical component of the lamp (10A-10J); or a second portion of the electrical component of the lamp (10A-10J) is plugged into a second portion of the power connecting port 120; or the first portion of the power connecting port 120 is plugged into the first portion of the electrical components of the lamp (10A-10J) and the second portion of the electrical component of the lamp (10A-10J) is plugged into the second portion of the power connecting port 120.

For instance, the power connecting port 120 is electrically connected to the electrical component (such as the light-emitting body 200) of the lamp (10A-10J), which means that at least two electrical connectors 121 of the power connecting port 120 abut against at least two electrical connectors 211 of the light-emitting body 200 to achieve power connecting. It is understandable that the at least two electrical connectors 121 of the power connecting port 120 are one-to-one corresponding to the at least two electrical connectors 211 of the light-emitting body 200.

The at least two electrical connectors 121 of the power connecting port 120 are configured to electrically connect with the at least two electrical connectors 211 of the light-emitting body 200 of the lamp.

In the embodiment of the present disclosure, the rotation of the terminal body 110 is equivalent to the rotation of the outer thread 111.

In the embodiment of the present disclosure, the rotation of the power connecting port 120 is equivalent to the rotation of the at least two electrical connectors 121 of the power connecting port.

It should be noted that the terminal body 110 and the power connecting port 120 are rotatable around the same axis or around different axes when the terminal body 110 and the power connecting port 120 rotate together. As shown in FIGS. 7A and 7B, the outer thread 111 of the wiring terminal 100A is rotatable around a first axis L1, and the power connecting port 120 is rotatable around a second axis L2. That is, the at least two electrical connectors 121 of the power connecting port 120 are rotatable around the second axis L2.

In one embodiment, as shown in FIGS. 7A-12B: the first axis L1 overlaps the second axis L2 of the wiring terminal 100 (100A-100F), so that the power connecting port 120 and the outer thread 111 are rotatable together around the first axis L1 or the second axis L2. It is understood that there are machining errors in an actual machining process of components of the lamp, and there are mounting errors in a mounting process of the wiring terminal and the light-emitting body 200. As long as a spacing between the first axis L1 and the second axis L2 is within a machining error range and/or a mounting error range, it is understood that the first axis L1 overlaps the second axis L2. The first axis L1 and the second axis L2 overlap, which is understood as the first axis L1 and the second axis L2 are coaxial.

In another embodiment, as shown in FIG. 15A and FIG. 15B: the first axis L1 and the second axis L2 of the wiring terminal 100I do not overlap. Specifically, the first axis L1 and the second axis L2 of the wiring terminal 100I are parallel to each other, and the spacing thereof is less than a predetermined value D, and the predetermined value D is greater than the machining error range and/or the mounting error range. For example, the predetermined value D is 0-2 mm. In the embodiment, the first axis L1 and the second axis L2 are parallel to each other. It is understood that when an angle formed between the first axis L1 and the second axis L2 is within the machining error range and/or the mounting error range, the first axis L1 and the second axis L2 are parallel to each other.

The power connecting port 120 is physically connected to the terminal body 110 directly or with an aid of other components. A connecting manner of the power connecting port 120 and the terminal body 110 is selected from a connecting manner A, a connecting manner B, a connecting manner C, and a connecting manner D.

In the connecting manner A, as shown in FIGS. 7A, 7B, 10, 11A, 12A, 15A, and 15B, at least portions of the at least two electrical connectors 121 of the power connecting port 120 of the wiring terminal (100A, 100D, 100E, 100F, 100I) protrude from the surface (such as the first end surface 113) of one end of the terminal body 110 along the first axis L1, and at least two electrical connectors 121 of the power connecting port 120 are allowed to be placed in the lampshade 300 from the first opening 310 of the lampshade 300 of the lamp (10A-10J) and are allowed to be taken out from the first opening 310 of the lampshade 300 of the lamp (10A-10J).

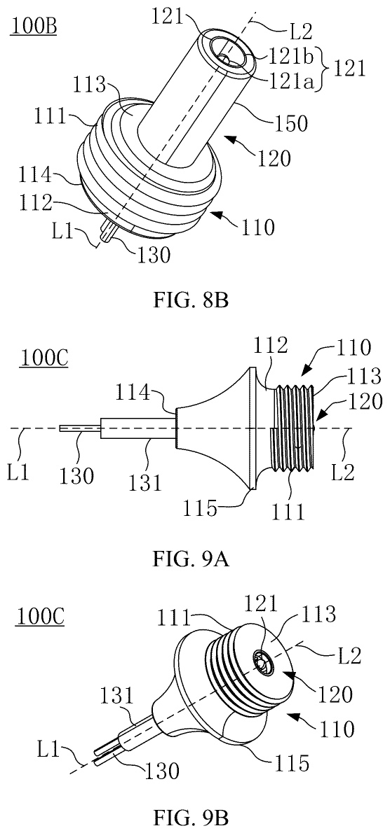

In the connecting manner B, as shown in FIGS. 8A-8B, the at least two electrical connectors 121 of the power connecting port 120 of the wiring terminal 100B are disposed on the surface (such as the first end surface 113) of the one end of the terminal body 110, and a protective sleeve150 is disposed on the first end surface 113 of the terminal body 110. The protective sleeve 150 is disposed around the at least two electrical connectors 121 of the power connecting port 120, so as to protect the at least two electrical connectors 121 of the power connecting port 120. Specifically, along the first axis L1, the at least two electrical connectors 121 of the power connecting port 120 are limited in the protective sleeve 150. The protective sleeve 150 prevents the power connecting port 120 from being directly exposed to the outside, and plays a protective role on the power connecting port 120, especially on the at least two electrical connectors 121 of the power connecting port 120. It is understood that the protective sleeve 150 of the embodiment of the present disclosure is made of non-conductive material, such as plastic. In some embodiments, as shown in FIGS. 8A and 8B, the protective sleeve 150 is connected to one of the electrical connectors 121 of the power connecting port 120. For instance, the one of the electrical connectors 121 of the power connecting port 120 is connected to an inner surface of the protective sleeve 150. In other embodiments, the protective sleeve150 is spaced apart from the at least two electrical connectors 121 of the power connecting port 120. It should be noted that the protective sleeve 150 may be disposed around the at least two electrical connectors 121 of the power connecting port 120, or may be disposed around portions of the at least two electrical connectors 121.

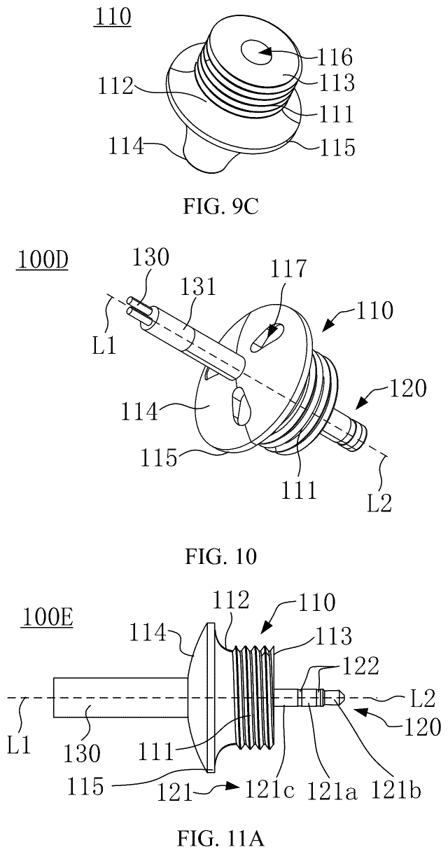

In the connecting manner C, as shown in FIGS. 9A, 9B and 9C: the one end (such as the first end surface 113) of the terminal body 110 of the wiring terminal 100C is recessed along the first axis L1 to define a receiving groove 116, and the at least two electrical connectors 121 of the power connecting port 120 are disposed in the receiving groove 116. Therefore, the at least two electrical connectors 121 of the power connecting port 120 do not protrude from the first end surface of the terminal body 110.

In the connecting manner D, as shown in FIGS. 7A, 7B, 9A, 9B and 9C: the at least two electrical connectors 121 of the power connecting port 120 are movable on the terminal body 110 along the first axis L1. That is, the at least two electrical connectors 121 of the power connecting port 120 are allowed to be received in the first end surface 113 of the terminal body, and are allowed to extend out of the first end surface 113 of the terminal body 110. Namely, when the power connecting port 120 and the terminal body 110 are connected, the at least two electrical connectors 121 of the power connecting port 120 move to drive the at least two electrical connectors 111 of the terminal body 110 to move, so as to change a positional relationship between the at least two electrical connectors 121 of the power connecting port 120 and the terminal body 110. Therefore, positions of the at least two electrical connectors 121 of the power connecting port 120 are adjusted according to user needs, which is beneficial for the user to assemble the lamp. It should be noted that in other embodiments, the power connecting port 120 is directly fixed on the terminal body 110 and is unable to move. Therefore, when it is not necessary to electrically connect the power connecting port 120 with the light-emitting body 200 of the lamp, the power connecting port 120 is driven to move to be received in the terminal body 110 without being exposed. When it is necessary to electrically connect the power connecting port 120 with the light-emitting body 200, the power connecting port 120 is driven to move out from the terminal body 110 and is exposed outside the first end surface of the terminal body 110 to electrically connect with the light-emitting body 200.

It should be noted that the above connecting manners of the power connecting port 120 and the terminal body 110 are only illustrative examples, and are not limitations on the connecting manners of the power connecting port 120 and the terminal body 110. The power connecting port 120 and the terminal body 110 may be connected in other ways. For example, the power connecting port 120 and the terminal body 110 are connected by one or more transition connectors. Specifically, when there is a transition connector, the transition connector is hollow, and the transition connector is detachably connected to the terminal body and the power connecting port. That is, both of the terminal body and the power connecting port are connected to the transition connector to achieve the connection of the power connecting port 120 and the terminal body 110, and both of the terminal body and the power connecting port are allowed to be removed from the transition connector to achieve separation of the power connecting port 120 and the terminal body 110. In the embodiment, the transition connector is rotatable relative to the lampshade and the terminal body of the lamp at the same time, and the transition connector may replace the terminal body mentioned above and be screwed with the inner thread of the lampshade, so that when the transition connector is connected to the lampshade, the terminal body and the power connecting port are stationary relative to the lampshade.

After the outer thread 111 of the terminal body 110 is completely screwed with the first inner thread 340 of the lampshade 300, the terminal body 110 seals the opening (such as the first opening 310) of the lampshade 300, so as to prevent liquid from entering an interior of the lampshade 300 from the first opening 310, thereby achieving the purpose of waterproofing.

In order to increase sealing performance of the terminal body 110 on the first opening 310, in one case, a flexible sealing pad is disposed between the terminal body 110 and the lampshade 300. In another case, as shown in FIG. 9A, 9B, 9C, 10, 11A and 12A, a sealing structure 115 is disposed on the outer side surface 112 of the terminal body 110 of the wiring terminal (100C, 100D, 100E and 100F). The sealing structure 115 is disposed around the outer side surface 112 of the terminal body 110. After the outer thread 111 of the terminal body 110 is completely screwed with the first inner thread 340 of the lampshade 300, the sealing structure 115 is attached to an outer surface of the lampshade 300. In order to increase connection stability and sealing between the terminal body 110 and the lampshade 300, as shown in FIGS. 27-36B, the lampshade 300 (lampshade 300A or lampshade 300B) defines a waterproof groove 360 communicated with the first opening 310. After the outer thread 111 of the terminal body 110 is completely screwed with the first inner thread 340 of the lampshade 300 (lampshade 300A or lampshade 300B), the sealing structure 115 is placed in the waterproof groove 360, and a surface of a junction between the sealing structure 115 and the lampshade 300 (lampshade 300A or lampshade 300B) is smoothly transitioned, so that the junction between the sealing structure 115 and the lampshade 300 (lampshade 300A or lampshade 300B) is smooth. It should be noted that when the sealing structure 115 is disposed on the outer side 112 of the terminal body 110, the flexible sealing pad is allowed to be disposed between the sealing structure 115 and the lampshade 300.

As shown in FIG. 10, in order to facilitate the rotation of the terminal body 110 of the wiring terminal 100D and connect the terminal body 110 to the lampshade 300, the terminal body 110 further comprises driving structures 117. The driving structures 117 are disposed on an end surface of the terminal body 110 away from the power connecting port 120. That is, the driving structures 117 are disposed on the second end surface 114 away from the first end surface 113. Specifically, the end surface of the terminal body 110 away from the power connecting port 120, that is, the second end surface 114, is recessed to form at least two clamping grooves (i.e., the drawing structures 117), and the at least two clamping grooves are configured for clamping legs of a tool to drive the terminal body 110 to rotate. For instance, the at least two clamping grooves are disposed at equal intervals around the first axis L1. It is understood that in one alternative embodiment, the driving structures 117 are protruded from the second end surface 114 of the terminal body 110, and in this case, the driving structures are configured as the handle pieces 14 shown in FIG. 2. In the embodiment of the present disclosure, the clamping grooves defined on the second end surface 114 of the terminal body 110 are configured as the driving structures 117, and legs of the tool are respectively plugged into the clamping grooves from the second end surface 114 of the terminal body, which facilitates an operator to operate the tool to drive the terminal body 110 to rotate relative to the lampshade 300, thereby tightly connecting the terminal body 110 and the lampshade 300 together. In a case shown in FIG. 2 where the driving structures 117 are the handle pieces 14 protruding from the second end surface 114 of the terminal body 110, the operator needs to use his fingers to act on the handle pieces 14. Since a strength of the fingers of different operators is different, when the strength of the fingers of the operator is small, the terminal body 110 and the lampshade 300 may not be tightly connected, resulting in the power connecting port 120 and the light-emitting body 200 of the lamp being not stably electrically connected, and resulting in the poor sealing performance between the terminal body 110 and the lampshade 300. On the contrary, the driving structures 117 are configured as the clamping grooves defined on the second end surface 114 of the terminal body 110, so the operator is able to plug the tool into the clamping grooves Then, the operator is able to operate the tool to drive the terminal body 110 to rotate relative to the lampshade 300. Commonly, the operators with different strengths are able to operate the tool to generate sufficient driving force to drive the terminal body 110 to rotate, thereby ensuring that the terminal body 110 and the lampshade 300 are tightly connected, and the power connecting port 120 and the light-emitting body 200 of the lamp are stably electrically connected.

In one embodiment, the driving structures 117 are disposed on the second end surface 114 at equal intervals around the first axis L1. In other optional embodiments, the driving structures 117 are disposed on the second end surface 114 at unequal intervals around the first axis L1.

As shown in FIGS. 7A-11B, 15A and 15B, the power connecting port 120 and the terminal body 110 of the wiring terminal (100A, 100B, 100C, 100D, 100E, 100I) are fixed together by injection molding.

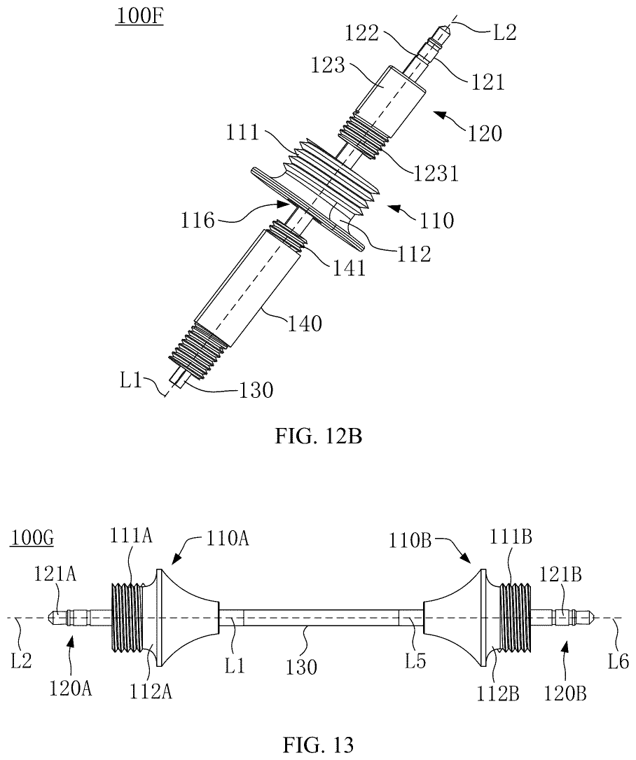

As shown in FIGS. 12A and 12B, the power connecting port 120 and the terminal body 110 of the wiring terminal 100F are connected together by mechanical connection. For example, the power connecting port 120 of the wiring terminal 100F further comprises a carrier 123, and the at least two electrical connectors 121 of the power connecting port 120 are separated and insulated by at least one insulating piece 122. The at least one insulating piece 122 and the at least two electrical connectors 121 are fixed on the carrier 123. The carrier 123 comprises an outer thread 1231, and the outer thread 1231 of the carrier 123 is screwed with a first inner thread of the terminal body 110. The first inner thread of the terminal body 110 is disposed on an inner surface of one side of the terminal body 110 close to the first end surface 113. Therefore, the power connecting port 120 is connected to the terminal body 110. In the embodiment, the wiring terminal 100F further comprises a connector 140 connected to the terminal body 110. Specifically, an outer thread 141 is disposed on a first end of the connector 140, and the outer thread 141 of the connector 140 is screwed with a second inner thread of the terminal body 110. The second inner thread of the terminal body 110 is disposed on an inner surface of one side of the terminal body 110 close to the second end surface 114. Thus, the terminal body 110 is connected to the connector 140. In one case, a second end of the connector 140 is connected to a base, so that the lamp is configured as a table lamp or a floor lamp. In another case, the second end of the connector 140 is staked into the ground, so that the lamp is configured as a garden lamp. In another case, the connector 140 is connected to another light-emitting body, so as to form the lamp configured as a light string. The second end of the connector 140 away from the terminal body 110 is allowed to be connected to a desired position according to user needs.

The above wiring terminal (100A-F, 100I) of the present disclosure comprises at least two wires 130, and the at least two wires 130 are one-to-one electrically connected to the at least two electrical connectors 121 of the power connecting port 120. It is understood that the number of the wires 130 is the same as the number of the electrical connectors 121 of the power connecting port 120, and each of the wires 130 is electrically connected to a corresponding electrical connector 121 of the power connecting port 120.

In some embodiments, as shown in FIG. 9A, FIG. 9B and FIG. 10, the wiring terminal 100C and the wiring terminal 100D further comprise a wire protective sleeve 131, and the wire protective sleeve 131 is sleeved on the at least two wires 130 to protect the wires 130. It should be noted that the wiring terminal in other embodiments may also comprise the wire protective sleeve 131 sleeved on the at least two wires.

The at least two electrical connectors 121 of the power connecting port 120 may comprise two electrical connectors 12, three electrical connectors 12, or four electrical connectors 12. The embodiments of the present disclosure do not limit the number of the electrical connectors 121 of the power connecting port 120.

When there are only two electrical connectors 121, the two electrical connectors 121 comprise a positive electrical connector and a negative electrical connector. The positive electrical connector is configured to be connected to a positive electrode of the mains or a positive electrode of a battery, and the negative electrical connector is configured to be connected to a negative electrode of the mains or a negative electrode of the battery. For instance, as shown in FIGS. 7B and 8B, the wiring terminal (100A and 100B) comprises two electrical connectors 121, which are respectively a first electrical connector 121a and a second electrical connector 121b. One of the first electrical connector 121a and the second electrical connector 121b is electrically connected to the mains or the positive electrode of the battery through a first wire130, and the other one of the first electrical connector 121a and the second electrical connector 121b is electrically connected to the mains or the negative electrode of the battery through a second wire 130.

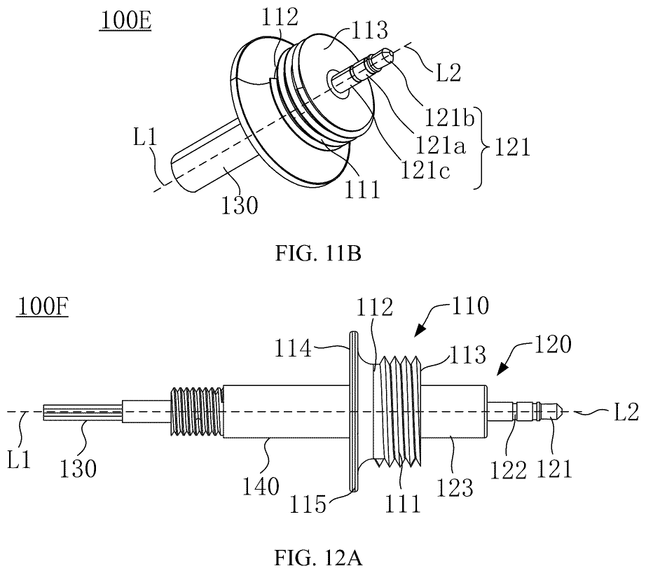

When there are three electrical connectors 121, the three electrical connectors 121 comprise a positive electrical connector, a negative electrical connector, and a control electrical connector. The positive electrical connector is configured to be connected to the positive electrode of an AC power or the positive electrode of the battery, the negative electrical connector is configured to be connected to a negative electrode of the AC power or the negative electrode of the battery, and the control electrical connector is configured to be electrically connected to a control component of the lamp. For instance, as shown in FIGS. 11A-12B, the wiring terminal (100E, 100F) comprises the three electrical connectors 121, which are respectively a first electrical connector 121a, a second electrical connector 121b, and a third electrical connector 121c. A first one of the first electrical connector 121a, the second electrical connector 121b. and the third electrical connector 121c is electrically connected to the positive electrode electrode of the AC power or the battery through a first wire 130. A second one of the first electrical connector 121a, the second electrical connector 121b and the third electrical connector 121c are electrically connected to the negative electrode of the AC power or the battery through a second wire 130. A third one of the first electrical connector 121a, the second electrical connector 121b and the third electrical connector 121c is electrically connected to the control component of the lamp through a third wire 130. The first electrical connector 121a, the second electrical connector 121b, and the third electrical connector 121c are connected to different objects. The control component of the lamp is, for example, a control circuit board, which is configured to control a light-emitting state of the light-emitting body 200 through a corresponding wire 130.

When there are four electrical connectors, the four electrical connectors 121 comprise a positive electrical connector, a negative electrical connector, and two control electrical connectors. The positive electrical connector is configured to be connected to the positive electrode of the mains or the positive electrode of the battery. The negative electrical connector is configured to be connected to the negative electrode of the mains or the negative electrode of the battery. The two control electrical connectors are configured to be electrically connected to the control component of the lamp.

The at least two electrical connectors 121 of the power connecting port 120 may be disposed according to a predetermined rule to facilitate the at least two electrical connectors 121 of the power connecting port 120 to rotate around the second axis L2.

In one embodiment, as shown in FIGS. 11A-12B, the at least two electrical connectors 121 of the power connecting port 120 of the wiring terminal (100E, 100F) are disposed along the second axis L2.

Specifically, as shown in FIGS. 20A-22B, the at least two electrical connectors of the power connecting port (120e, 120f, 120g) of the wiring terminal 100 are disposed along the second axis L2.

As shown in FIGS. 20A and 20B, the power connecting port 120e comprises one insulating piece 122. The insulating piece 122 comprises a receiving cavity 1222 and an opening 1221 communicated with the receiving cavity 1222. Each of the electrical connectors of the power connecting port 120e is fixed by the insulating piece 122 and does not contact the insulating piece 122. Specifically, the power connecting port 120e comprises the three electrical connectors, which are respectively the first electrical connector 121a, the second electrical connector 121b, and the third electrical connector 121c. A portion of the first electrical connector 121a, a portion of the second electrical connector 121b, and a portion of the third electrical connector 121c are in the receiving cavity 1222. The portion of the first electrical connector 121a, the portion of the second electrical connector 121b, and the portion of the third electrical connector 121c are disposed in sequence in the receiving cavity 1222 along the second axis L2. The portion of the first electrical connector 121a, the portion of the second electrical connector 121b, and the portion of the third electrical connector 121c are configured to electrically connect with the electrical component of the lamp. For instance, a portion of the light-emitting body 200 of the lamp is plugged into the receiving cavity 122 to electrically connect with the first electrical connector 121a, the second electrical connector 121b and the third electrical connector 121c. The portion of the first electrical connector 121a, the portion of the second electrical connector 121b, and the portion of the third electrical connector 121c are fixed in the insulating piece 122 and separated by the insulating piece 122 without contacting each other. A rest portion of the first electrical connector 121a, a rest portion of the second electrical connector 121b and a rest portion of the third electrical connector 121c are exposed outside one end of the insulating piece 122 away from the opening 1221 and are electrically connected to the three wires 130 in the above embodiments, so that the first electrical connector 121a, the second electrical connector 121b, and the third electrical connector 121c are connected to the mains or the battery and the control component of the lamp through the wires 130 described in the above embodiments. In the embodiment, the portion of each of the electrical connectors fixed in the insulating piece 122 is disposed along the second axis L2. When the power connecting port 120e is plugged into the light-emitting body 200 of the lamp, a portion of the light-emitting body 200 is plugged into the receiving cavity 1222 of the power connecting port 120e. At the same time, one of the three electrical connectors of the power connecting port 120e, such as the first electrical connector 121a, is plugged into the light-emitting body 200.

It should be noted that the number of the electrical connectors in FIGS. 20A and 20B is not limited to three, and may be set to two or four similarly.

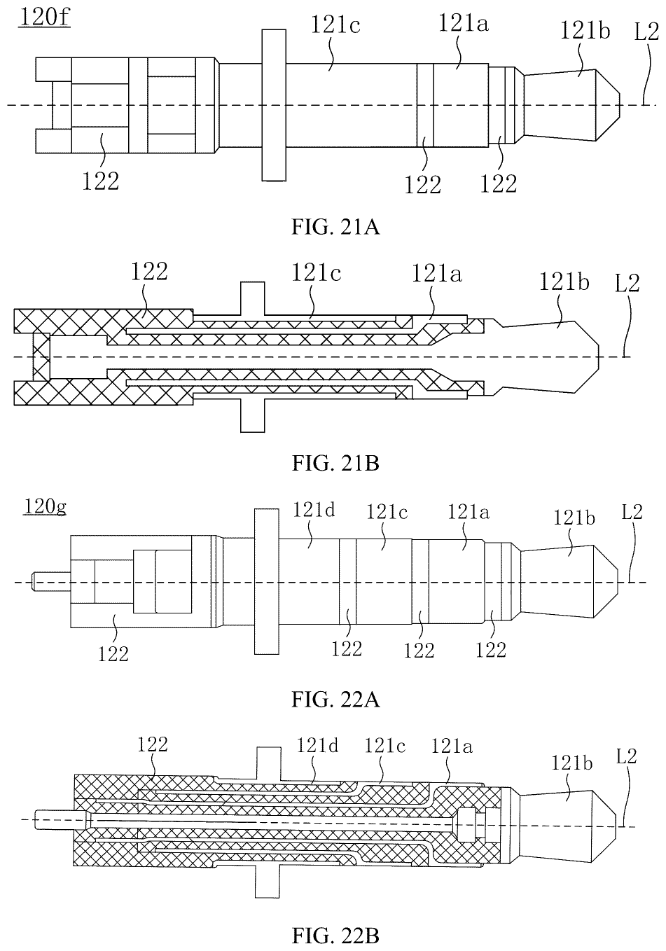

As shown in FIGS. 21A, 21B, 22A, and 22B, the at least one insulating pieces 122 comprises insulating pieces 122, and each of the electrical connectors of the power connecting port (120f, 120g) is partially disposed in a corresponding insulating piece 122. In other words, each of the electrical connectors of the power connecting port (120f, 120g) is partially exposed outside the corresponding insulating piece 122.

For example, the power connecting port 120f comprises three electrical connectors, which are the first electrical connector 121a, the second electrical connector 121b and the third electrical connector 121c. The portion of the first electrical connector 121a, the portion of the second electrical connector 121b and the portion of the third electrical connector 121c are respectively disposed in the insulating pieces 122 and are separated by the insulating pieces 122 without contacting each other. The rest portion of the first electrical connector 121a, the rest portion of the second electrical connector 121b and the rest portion of the third electrical connector 121c are respectively exposed outside the insulating pieces 122. The rest portion of the first electrical connector 121a, the rest portion of the second electrical connector 121b and the rest portion of the third electrical connector 121c are plugged into the light-emitting body 200 of the lamp to achieve power connecting of the wiring terminal and the light-emitting body 200. The rest portion of the first electrical connector 121a, the rest portion of the second electrical connector 121b and the rest portion of the third electrical connector 121c that are exposed outside the insulating pieces 122 are disposed along the second axis L2. Specifically, the rest portion of the third electrical connector 121c, the rest portion of the first electrical connector 121a and the rest portion of the second electrical connector 121b are disposed in sequence along the second axis L2. It is understood that the first electrical connector 121a, the second electrical connector 121b, and the third electrical connector 121c of the power connecting port 120f are electrically connected to the mains or the battery and the control component of the lamp through the wires 130. In the process of plugging the power connecting port 120f with the light-emitting body 200 of the lamp, the rest portion of the first electrical connector 121a, the rest portion of the second electrical connector 121b and the rest portion of the third electrical connector 121c of the power connecting port 120f are plugged into the light-emitting body 200 to achieve power connecting.

For example, the power connecting port 120g comprises four electrical connectors, which are the first electrical connector 121a, the second electrical connector 121b, the third electrical connector 121c, and the fourth electrical connector 121d. The portion of the first electrical connector 121a, the portion of the second electrical connector 121b, the portion of the third electrical connector 121c, and the portion of the fourth electrical connector 121d are respectively disposed in the insulating pieces 122 and are separated by the insulating pieces 122 without contacting each other. The rest portion of the first electrical connector 121a, the rest portion of the second electrical connector 121b, the rest portion of the third electrical connector 121c, and the rest portion of the fourth electrical connector 121d are respectively exposed outside the insulating pieces 122. The rest portion of the first electrical connector 121a, the rest portion of the second electrical connector 121b, the rest portion of the third electrical connector 121c, and the rest portion of the fourth electrical connector 121d are plugged into the light-emitting body 200 of the lamp to achieve power connecting of the wiring terminal and the light-emitting body 200. The rest portion of the first electrical connector 121a, the rest portion of the second electrical connector 121b, the rest portion of the third electrical connector 121c, and the rest portion of the fourth electrical connector 121d are disposed along the second axis L2. Specifically, the rest portion of the fourth electrical connector 121d, the rest portion of the third electrical connector 121c, the rest portion of the first electrical connector 121a and the rest portion of the second electrical connector 121b are disposed in sequence along the second axis L2. It is understood that the first electrical connector 121a, the second electrical connector 121b, the third electrical connector 121c, and the fourth electrical connector 121d of the power connecting port 120f are electrically connected to the mains or the battery and the control component of the lamp through the wires 130.

For example, the third electrical connector 121c and the fourth electrical connector 121d are configured to electrically connect with the control component of the lamp. The control component is the controller of the lamp, such as the control circuit board. The control circuit board is electrically connected to the third electrical connector 121c and the fourth electrical connector 121d through corresponding two wires 130, so as to control the brightness, duration, mode and color of the light emitted by the light-emitting body 200. In the process of plugging the power connecting port 120g with the light-emitting body 200 of the lamp, the rest portion of the first electrical connector 121a, the rest portion of the second electrical connector 121b, the rest portion of the third electrical connector 121c, and the rest portion of the fourth electrical connector 121d are plugged into the light-emitting body 200 to realize power connecting. The light mode comprises constant light, flashing, etc.

In another embodiment, as shown in FIGS. 7B and 8B, at least portions of the at least two electrical connectors 121 of the power connecting port 120 of the wiring terminal (100A, 100B) are disposed along a direction perpendicular to the second axis L2.

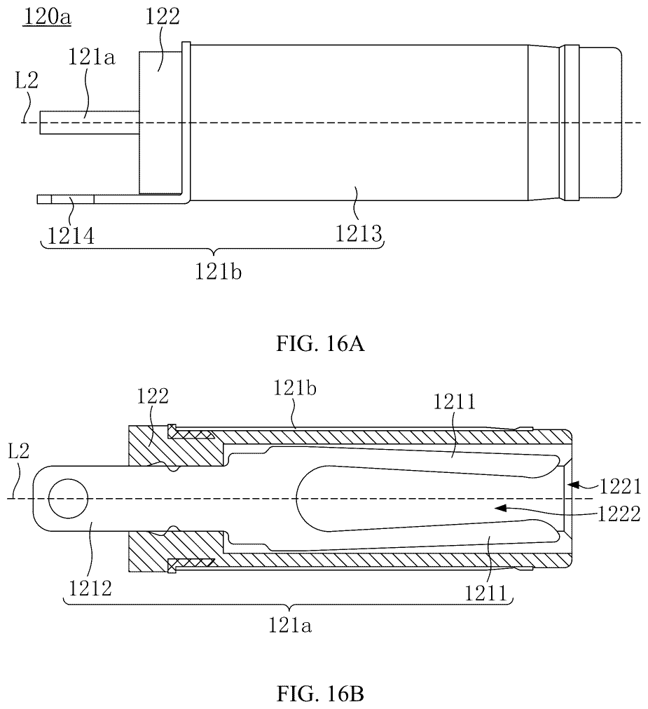

Specifically, as shown in FIGS. 16A-19B: at least portions of the electrical connectors 121 of the power connecting port (120a, 120b, 120c, 120d) are disposed along the direction perpendicular to the second axis L2.

Specifically, as shown in FIG. 16A and FIG. 16B, the power connecting port 120a comprises two electrical connectors, namely, the first electrical connector 121a and the second electrical connector 121b. The power connecting port 120a comprises one insulating piece 122. The insulating piece 122 comprises the receiving cavity 1222 and the opening 1221 communicating with the receiving cavity 1222. A first portion of the first electrical connector 121a is disposed inside the insulating piece 122, a second portion thereof is disposed in the receiving cavity 1222, and a third portion thereof is disposed outside the one end of the insulating piece away from the opening 1221. Specifically, the second portion of the first electrical connector 121a disposed in the receiving cavity 1222 is defined as first power connecting portions 1211. There are two first power connecting portions 1211, and the two first power connecting portions 1211 are configured to electrically connect to the portion of the light-emitting body 200 plugged into the receiving cavity 1222. The third portion of the first electrical connector 122a disposed outside the insulating piece is defined as a second electrical connecting portion 1212. The second electrical connecting portion 1212 is configured to electrically connect to the corresponding wire 130. The second power connecting portion 1212 is electrically connected to the mains or one of the electrodes of the battery through the corresponding wire 130. A first portion of the second electrical connector 121b disposed outside the insulating piece is disposed along the direction perpendicular to the second axis L2 and is defined as a third power connecting portion 1213. The second portion of the first electrical connector 121a disposed in the receiving cavity 1222 is disposed along the direction perpendicular to the second axis L2. The third power connecting portion 1213 is configured to electrically connect to the light-emitting body 200 when the third power connecting portion 1213 is plugged into the light-emitting body 200. A second portion of the second electrical connector 121b is exposed outside the one end of the insulating piece away from the opening 1221 and is defined as a fourth power connecting portion 1214. The fourth power connecting portion 1214 is electrically connected to the corresponding wire130 and is electrically connected to the mains or another electrode of the battery. When the power connecting port 120a is plugged into the electrical component, such as the light-emitting body 200, of the lamp, the portion of the light-emitting body 200 is plugged into the power connecting port 120a, specifically, into the receiving cavity 1222 of the power connecting port 120a. At this time, one of the electrical connectors of the power connecting port 120a, such as the second electrical connector 121b, is plugged into the light-emitting body 200. The two first power connecting portions 1211 and the third power connecting portion 1213 are disposed along the direction perpendicular to the second axis L2. The second power connecting portion 1212 and the fourth power connecting portion 1214 are disposed along the direction perpendicular to the second axis L2. In some cases, the third power power connecting portion 1213 is disposed around the two first power connecting portions 1211.

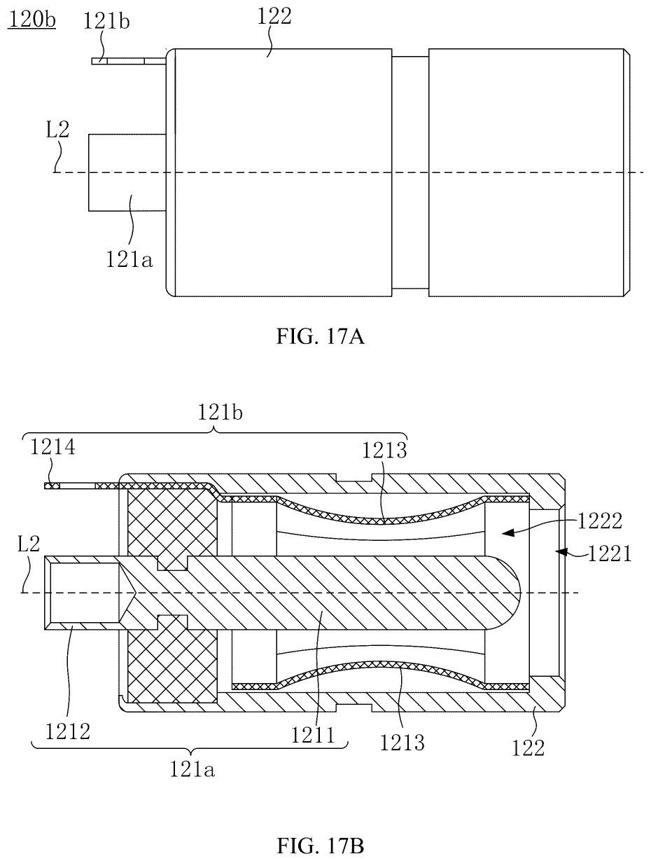

For example, as shown in FIGS. 17A and 17B, the power connecting port 120b comprises two electrical connectors, which are the first electrical connector 121a and the second electrical connector 121b. The power connecting port 120b further comprises the insulating piece 122. The insulating piece 122 comprises the receiving cavity 1222 and the opening 1221 communicated with the receiving cavity 1222. First portions of the first electrical connector 121a and the second electrical connector 121b are disposed inside the insulating piece 122, second portions of the first electrical connector 121a and the second electrical are disposed in the receiving cavity 1222, and third portions of the first electrical connector 121a and the second electrical are disposed outside the one end of the insulating piece away from the opening 1221. The second portion of the first electrical connector 121a and the second portion of the second electrical connector 121b are respectively defined as the first power connecting portion 1211 and the third power connecting portion 1213. The third portion of the first electrical connector 121a and the third portion of the second electrical connector 121b are respectively defined as the second power connecting portion 1212 and the fourth power connecting portion 1214. The third power connecting portion 1213 is configured to electrically connect with the portion of the light-emitting body 200 plugged into the receiving cavity 1222. The first power connecting portion 1211 is configured to electrically connect with the portion of the light-emitting body 200 plugged into the receiving cavity 1222.

The second power connecting portion 1212 is configured to electrically connect with the first wire 130. The second power connecting portion 1212 is electrically connected to one of the electrodes of the mains or the battery through the first wire 130. The fourth power connecting portion 1214 is configured to electrically connect with the second wire 130, and the fourth power connecting portion 1214 is electrically connected to the other one of the electrodes of the mains or the battery through the second wire 130. During the process of plugging the power connecting port 120a with the light-emitting body 200 of the lamp, the portion of the light-emitting body 200 is plugged into the receiving cavity 1222 of the power connecting port 120a. A portion of the power connecting port 120b, such as the first power connecting portion 1211, is plugged into the light-emitting body 200. The first power connecting portion 1211 and the third power connecting portion 1213 are disposed in the direction perpendicular to the second axis L2. The second power connecting portion 1212 and the fourth power connecting portion 1214 are disposed along the direction perpendicular to the second axis L2. In some cases, the third power connecting portion 1213 is disposed around the first power connecting portion 1211.

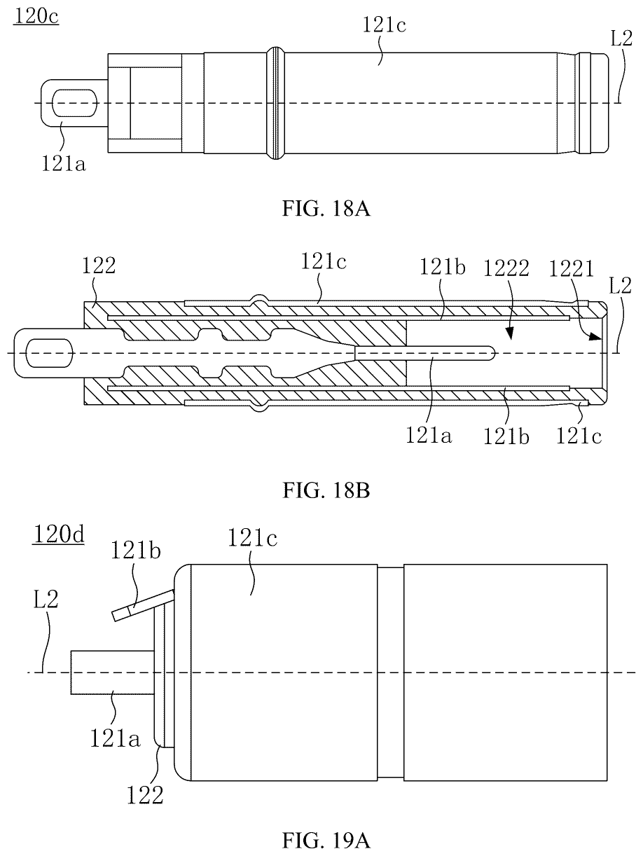

For example, as shown in FIGS. 18A and 18B, the power connecting port 120c comprises three electrical connectors, which are the first electrical connector 121a, the second electrical connector 121b, and the third electrical connector 121c. The power connecting port 120c further comprises the insulating piece 122. The insulating piece 122 comprises the receiving cavity 1222 and the opening 1221 communicated with the receiving cavity 1222. The first portion of the first electrical connector 121a is disposed inside the insulating piece 122, the second portion thereof is disposed in the receiving cavity 1222, and the third portion thereof is disposed outside the one end of the insulating piece away from the opening 1221. The second portion of the first electrical connector 121a disposed in the receiving cavity 1222 is configured to be plugged into the light-emitting body 200 and electrically connected to the light-emitting body 200. The third portion of the first electrical connector 122a is configured to be electrically connected to the first wire 130. The first electrical connector 122a is electrically connected to the mains or one of the electrodes of the battery through the first wire 130. A first portion of the second electrical connector 121b is disposed in the receiving cavity 1222 and is attached to an inner side of the receiving cavity 1222. The first portion of the second electrical connector 121b is configured to electrically connect with the portion of the light-emitting body 200 plugged into the receiving cavity 1222. A second portion of the second electrical connector 121b is exposed to the outside of the one end of the insulating piece away from the opening 1221 and is electrically connected to the second wire 130. The second electrical connector 121b is electrically connected to the mains or the other one of the electrodes of the battery through the second wire 130. At least a portion of the third electrical connector 121c is disposed outside the insulating piece, and is electrically connected to the portion of the light-emitting body 200 when it is inserted into the light-emitting body 200. The third electrical connector 121c is electrically connected to the control component of the lamp through the third wire 130. The first electrical connector 121a, the second electrical connector 121b and the third electrical connector 121c are disposed in the direction perpendicular to the second axis L2. The power connecting port 120c is plugged into the light-emitting body 200 of the lamp to realize the electrical connection.

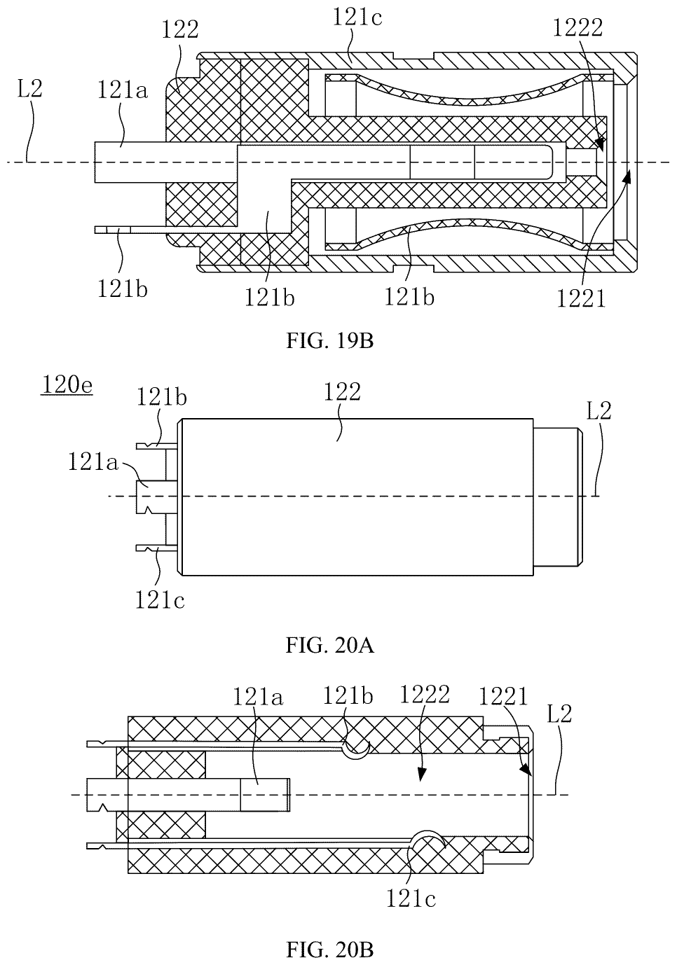

For example, as shown in FIGS. 19A and 19B, the power connecting port 120d comprises three electrical connectors, which are the first electrical connector 121a, the second electrical connector 121b, and the third electrical connector 121c. The power connecting port 120c further comprises the insulating piece 122. The insulating piece 122 comprises the receiving cavity 1222 and the opening 1221 communicated with the receiving cavity 1222. The first portion of the first electrical connector 121a is disposed inside the insulating piece 122, the second portion thereof is disposed in the receiving cavity 1222, and the third portion thereof is disposed outside the one end of the insulating piece away from the opening 1221. The second portion of the first electrical connector 121a disposed in the receiving cavity 1222 is configured to be plugged into the light-emitting body 200 and electrically connected to the light-emitting body 200. The third portion of the first electrical connector 122a is configured to be electrically connected to the first wire 130. The first electrical connector 122a is electrically connected to the mains or one of the electrodes of the battery through the first wire 130.

The first portion of the second electrical connector 121b is disposed inside the insulating piece 122, the second portion thereof is disposed around the receiving cavity 1222, and the third portion thereof is disposed outside the one end of the insulating piece away from the opening 1221. The second portion of the second electrical connector 121b is disposed around the receiving cavity and is spaced from the receiving cavity. The portion of the light-emitting body 200 is plugged into the receiving cavity 1222 and electrically connected to the first electrical connector 121a, while the portion of the light-emitting body 200 is sleeved on the second portion of the second electrical connector and electrically connected to the second electrical connector 121b. The third portion of the second electrical connector 121b is electrically connected to the second wire 130 to be electrically connected to the mains or the other one of the electrodes of the battery. The third electrical connector 121c is disposed around the second electrical connector 121b for electrically connecting to the light-emitting body 200. The first electrical connector 121a, the second electrical connector 121b and the third electrical connector 121c are disposed in the direction perpendicular to the second axis L2. During the process of plugging the power connecting port 120c with the light-emitting body 200 of the lamp, the power connecting port 120c and the light-emitting body 200 are plugged into each other.

FIGS. 16A, 16B, 17A, 17B, 18A, 18B, 19A, 19B, 20A, 20B, 21A, 21B, 22A, and 22B are embodiments of the power connecting port 120 disclosed in the present disclosure, and types of the power connecting port 120 are not limited thereto.

The at least two electrical connectors of the power connecting port of different embodiments extend along the second axis L2. It should be noted that extension lengths of the at least two electrical connectors of the power connecting port along the second axis L2 are the same or different. When the extension lengths of the at least two electrical connectors of the power connecting port along the second axis L2 are different, the at least two electrical connectors of the power connecting port are disposed in sequence along the second axis L2, or the at least two electrical connectors of the power connecting port are disposed along the direction perpendicular to the second axis L2. When the extension lengths of the at least two electrical connectors of the power connecting port along the second axis L2 are the same, the at least two electrical connectors of the power connecting port are disposed in the direction perpendicular to the second axis L2.

The electrical connectors of the power connecting port are at least partially disposed in the direction perpendicular to the second axis L2, and ends of the electrical connectors may be aligned or staggered. When the ends of the electrical connectors are staggered, the arrangement relationship of the electrical connectors is understood as that the electrical connectors are disposed along the second axis L2, and are disposed along the direction perpendicular to the second axis L2. When the ends of the electrical connectors are aligned, the arrangement relationship of the electrical connectors is understood as that the electrical connectors are disposed in the direction perpendicular to the second axis L2. It should be noted that when there is an electrical connector disposed around another electrical connector, in any direction perpendicular to the second axis L2, the surrounding electrical connector and the electrical connector are disposed in the direction perpendicular to the second axis L2. Therefore, when there is the electrical connector disposed around another electrical connector, it is understood that the electrical connectors are disposed in the direction perpendicular to the second axis L2.

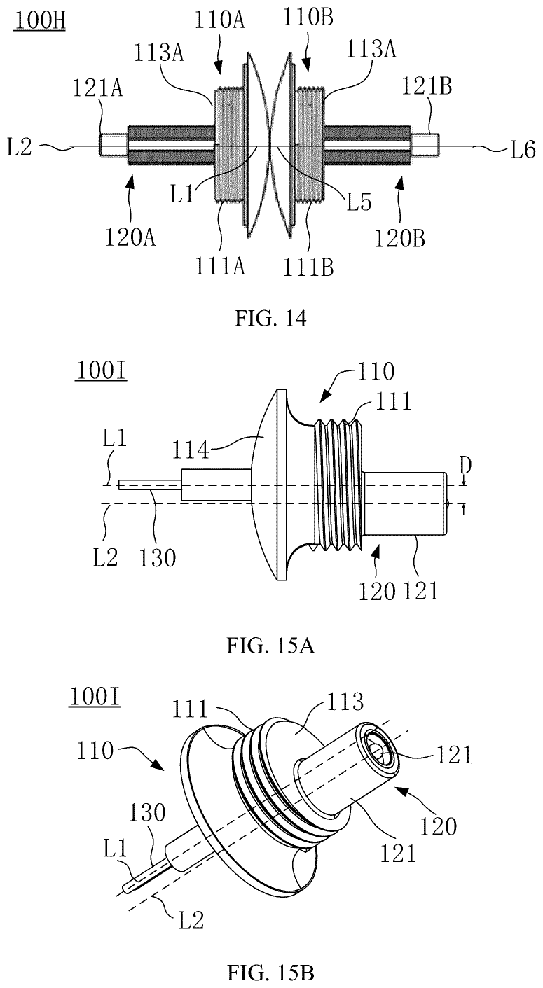

As shown in FIGS. 13-14, in some embodiments, the wiring terminal (100G, 100H) comprises two terminal bodies 110 and two power connecting ports 120. Specifically, the two terminal bodies 110 comprise a first terminal body 110A and a second terminal body 110B, and the two power connecting ports 120 comprise a first power connecting port 120A and a second power connecting port 120B.

As shown in FIGS. 13 and 14, the first terminal body 110A is connected to the first power connecting port 120A, and the first terminal body 110A and the first power connecting port 120A are rotatable together. The first terminal body 110A is rotatable around the first axis L1, and the first power connecting port 120A is rotatable around the second axis L2. The first terminal body 110A of the embodiment may refer to the terminal body 110 in the above embodiments, and the first power connecting port 120A of the embodiment may refer to the power connecting port 120 in the above embodiments. For instance, the first terminal body 110A comprises a first outer thread 111A disposed on a first outer side of the first terminal body 110A, and the first power connecting port 120A comprises at least two electrical connectors 121A. The first outer thread 111A may refer to the outer thread 111, and the at least two electrical connectors 121A may refer to the at least two electrical connectors 121 in the above embodiments, which are not repeatedly described herein. A connection relationship between the first terminal body 110A and the first power connecting port 120A in the embodiment of the present disclosure may refer to the connection relationship between the terminal body 110 and the power connecting port 120 in the above embodiments, which is not repeatedly described herein.

As shown in FIGS. 13 and 14, the second terminal body 110B is connected to the second power connecting port 120B, and the second terminal body 110B and the second power connecting port 120B are rotatable together, the second terminal body 110B is rotatable around a fifth axis L5, and the second power connecting port 120B is rotatable around a sixth axis L6. The second terminal body 110B of the embodiment may also refer to the terminal body 110 in the above embodiments, and the second power connecting port 120B of the embodiment may also refer to the power connecting port 120 in the above embodiments. Specifically, the second terminal body 110B comprises a second outer thread 111B disposed on a second outer side of the second terminal body 110B, and the second power connecting port 120B comprises at least two electrical connectors 121B. The second outer thread 111B of the second terminal body 110B may refer to the outer thread 111 of the terminal body 110, and the at least two electrical connectors 121B may refer to the at least two electrical connectors 121 in the above embodiments, which are not repeatedly described herein. A connection relationship between the second terminal body 110B and the second power connecting port 120B in the embodiment of the present disclosure may refer to the connection relationship between the terminal body 110 and the power connecting port 120 in the above embodiments, which is not repeatedly described herein. A relationship between the fifth axis L5 and the sixth axis L6 may refer to the relationship between the first axis L1 and the second axis L2 in the above embodiments, which is not repeatedly described herein.

As shown in FIGS. 13 and 14, the first power connecting port 120A and the second power connecting port 120B are connected by the wires 130. Specifically, the at least two electrical connectors 121A of the first power connecting port 120A are connected to the at least two electrical connectors 121B of the second power connecting port 120B by the wires 130.

As shown in FIG. 13, the first terminal body 110A and the second terminal body 110B are disposed at intervals. Specifically, the first terminal body 110A and the second terminal body 110B are spaced apart by the wires 130 and are not directly connected. The first terminal body 110A and the second terminal body 110B are movable relative to each other through the wires 130. For example, the first terminal body 110A and the second terminal body 110B are bending relative to each other. A length of the wires 130 between the first terminal body 110A and the second terminal body 110B in the embodiment of the present disclosure are freely determined according to requirements to define a distance between two lampshades, when the first terminal body 110A and the second terminal body 110B are respectively mounted on the two lampshades.

As shown in FIG. 14, the first terminal body 110A and the second terminal body 110B are directly connected. Specifically, an end surface of the first terminal body 110A away from the first end surface 113A is directly connected to an end surface of the second terminal body 110B away from the first end surface 113B. In the embodiment, the first axis L1, the second axis L2, the fifth axis L5, and the sixth axis L6 shown in FIG. 14 are overlapped within the machining error range.

As shown in FIGS. 13-14, a shape of the first terminal body 110A is the same or different from a shape of the second terminal body 110B.

As shown in FIGS. 13-14, a shape of the first power connecting port 120A is the same or different from a shape of the second power connecting port 110B.

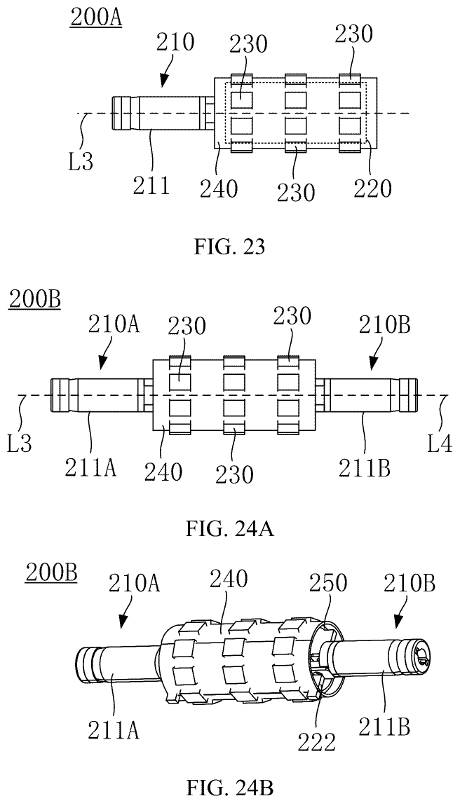

As shown in FIG. 23, the light-emitting body 200A of the lamp (hereafter the light-emitting body 200A) comprises one or more light-emitting elements 230, a rigid circuit board 220, and a power connecting plug 210. The rigid circuit board 220 is electrically connected to the one or more light-emitting elements 230 to control the one or more light-emitting elements 230 to emit light. The one or more light-emitting elements 230 are LED lamp beads. The power connecting plug 210 is rigidly fixed to the rigid circuit board 220, and the power connecting plug 210 is electrically connected to the rigid circuit board 220. The power connecting plug 210 comprises at least two electrical connectors 211, and the at least two electrical connectors 211 of the power connecting plug 210 are rotatable around a third axis L3. The power connecting plug 210 is configured to be plugged into the power connecting port 120 of the lamp so that the at least two electrical connectors 211 of the power connecting plug 210 are electrically connected to the at least two electrical connectors 121 of the power connecting port 120. It should be noted that the power connecting plug 210 is also allowed to be plugged into the first power connecting port 120A or the second power connecting port 120B of the lamp.

It is understood that after the power connecting plug 210 is plugged into the power connecting port 120, the at least two electrical connectors 211 are correspondingly connected to the at least two electrical connectors 121. Specifically, the electrical connectors of different polarities are correspondingly connected, thereby realizing the electrical connection between the power connecting plug 210 and the power connecting port 120.

In the embodiment, the one or more light-emitting elements 230 and the rigid circuit board 220 may be directly physically connected or indirectly physically connected.

In one case, the one or more light-emitting elements 230 are indirectly physically connected to the rigid circuit board 220, and the one or more light-emitting elements 230 are physically and electrically connected to the rigid circuit board 220 through a flexible circuit board 240. Specifically, the one or more light-emitting elements 230 are disposed on a first side of the flexible circuit board 240, and a second side of the flexible circuit board 240 is disposed around the rigid circuit board 220. The flexible circuit board 240 is disposed around a peripheral side of the rigid circuit board 220 to expose at least one end surface of the rigid circuit board 220, which is conducive to an electrical connection between the end surface of the rigid circuit board 220 and the power connecting plug 210. In other words, the flexible circuit board 240 is at least disposed around the peripheral side of the rigid circuit board 220 without covering the at least one end surface of the rigid circuit board 220, so as to ensure that the power connecting plug 210 is electrically connected to the rigid circuit board 220. The flexible circuit board 240 is electrically connected to the rigid circuit board 220 through a conductive line, or the flexible circuit board 240 is directly welded to the rigid circuit board 220 to achieve electrical connection therebetween.

The light-emitting body 200A in the embodiment comprises only one power connecting plug 210. It should be noted that in other embodiments, the light-emitting body comprises at least two power connecting plugs, such as two power connecting plugs, three power connecting plugs, four power connecting plugs, etc.

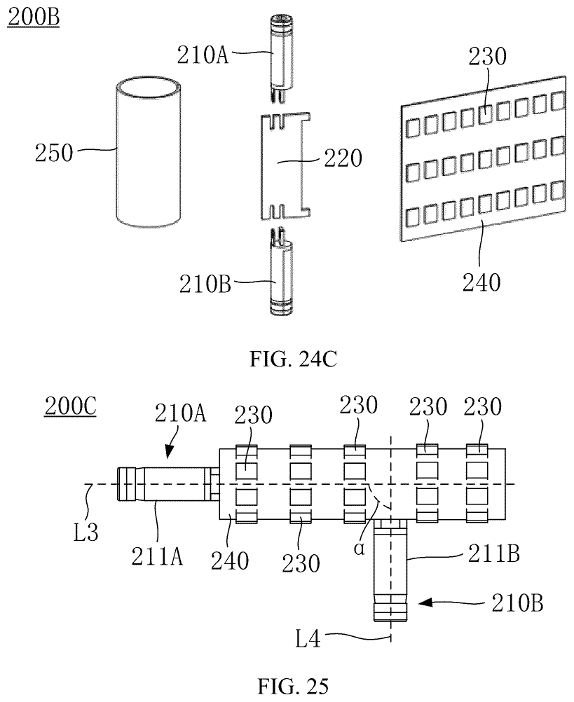

As shown in FIGS. 24A-24C, a difference between the light-emitting body 200B and the light-emitting body 200A is that the light-emitting body 200B comprises two power connecting plugs. The two power connecting plugs comprise a first power connecting plug 210A and a second power connecting plug 210B. The first power connecting plug 210A and the second power connecting plug 210B are fixed to and electrically connected to the rigid circuit board 220. The way in which the first power connecting plug 210A and the second power connecting plug 210B are fixed to and electrically connected to the rigid circuit board 220 may refer to the way in which the power connecting plug 210 is fixed to and electrically connected to the rigid circuit board 220, which is not repeatedly described herein.

Each of the first power connecting plug 210A and the second power connecting plug 210B each comprises at least two electrical connectors. Specifically, the first power connecting plug 210A comprises at least two electrical connectors 211A, and the second power connecting plug 210B comprises at least two electrical connectors 211B. The first power connecting plug 210A is plugged into the power connecting port 120 of the lamp, so that the at least two electrical connectors 211A of the first power connecting plug 210A are electrically connected to the at least two electrical connectors 121 of the power connecting port 120. The first power connecting plug 210B is also allowed to be plugged into another electrical component of the lamp, such as a solar panel 400, so that the at least two electrical connectors 211A of the first power connecting plug 210A are electrically connected to the solar panel 400. Similarly, the second power connecting plug 210B is able to be plugged into the power connecting port 120 of the lamp, so that the at least two electrical connectors 211B of the second power connecting plug 210B are electrically connected to the at least two electrical connectors 121 of the power connecting port 120. The second power connecting plug 210B is also allowed to be plugged into another electrical component of the lamp, such as the solar panel 400, so that the at least two electrical connectors 211B of the second power connecting plug 210B are electrically connected to the solar panel 400.

Optionally, the at least two electrical connectors 211A of the first power connecting plug 210A are rotatable around the third axis L3, and the at least two electrical connectors 211B of the second power connecting plug 210B are rotatable around the fourth axis L4.

Optionally, the at least two electrical connectors 211A of the first power connecting plug 210A and the at least two electrical connectors 211B of the second power connecting plug 210B are rotatable around the third axis L3 or the fourth axis L4. Namely, the first power connecting plug 210A and the second power connecting plug 210B are coaxially disposed.

Optionally, the first power connecting plug 210A and the second power connecting plug 210B are symmetrically disposed relative to the rigid circuit board 220.

Optionally, a structure of the first power connecting plug 210A is the same as a structure of the second power connecting plug 210B.

Optionally, the one or more light-emitting elements 230 are disposed on the first side of the flexible circuit board 240, and the second side of the flexible circuit board 240 where the one or more light-emitting elements 230 are not disposed is attached to at least one support 250. That is, a non-luminous surface of the flexible circuit board 250 is disposed on an outer surface of the support 250, and the support 250 is configured to support the flexible circuit board 240. The support 250 is sleeved on the rigid circuit board 220, and the support 250 is disposed around the rigid circuit board 220 and is physically connected to the rigid circuit board 220. It should be noted that the first power connecting plug 210A and/or the second power connecting plug 210B may be fixed to and electrically connected to the peripheral side of the rigid circuit board 220. For instance, the first power connecting plug 210A and/or the second power connecting plug 210B may be fixed to and electrically connected to the peripheral side of the rigid circuit board 220 via a through hole on the flexible circuit board.

It should be noted that the light-emitting body 200A shown in FIG. 23 may further comprise a support 250 as shown in FIG. 24C, which is not described in detail herein.

In one embodiment, as shown in FIG. 25, a difference between the light-emitting body 200C and the light-emitting body 200B is that the first power connecting plug 210A and the second power connecting plug 210B define an angle α greater than 0 degrees and less than 180 degrees. The angle α is understood as an angle defined by the third axis L3 and the fourth axis L4. For example, when the third axis L3 and the fourth axis L4 are perpendicular to each other, and the angle α is 90 degrees. Other components of the light-emitting body 200C, such as the one or more light-emitting elements 230, the flexible circuit board 240, and the rigid circuit board may refer to that of the light-emitting body 200B, which are not described in detail herein.

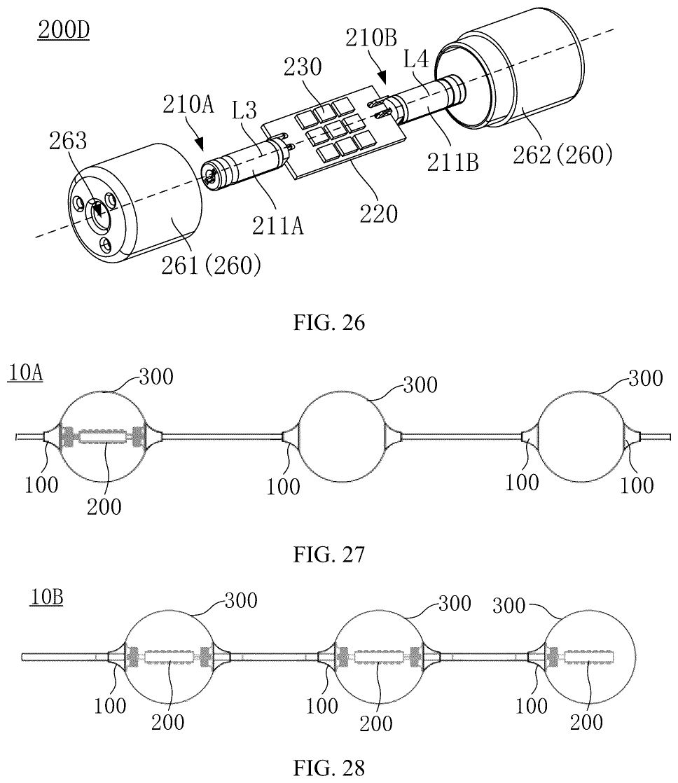

In another embodiment, as shown in FIG. 26, the light-emitting body 200D is different from the light-emitting body 200B and the light-emitting body 200C. Specifically, the one or more light-emitting elements 230 are directly disposed on at least one side of the rigid circuit board 220, but not disposed on the flexible circuit board. The light-emitting body 200D further comprises an outer sleeve260. The outer sleeve260 is disposed around the rigid circuit board 220 to cover the one or more light-emitting elements 230. The outer sleeve260 of the embodiment of the present disclosure is at least light-transmissive, so that the light emitted by the one or more light-emitting elements 230 covered by the outer sleeve260 is able to penetrate through the outer sleeve260. The outer sleeve260 is opaque or transparent. When the outer sleeve260 is opaque, it prevents the user from seeing the one or more light-emitting elements 230 in the outer sleeve260 through the outer sleeve260. When the outer sleeve260 is transparent, the user is able to see the one or more light-emitting elements 230 in the outer sleeve260 through the outer sleeve260. The rigid circuit board 220 may comprise two sides, three sides, four sides or more sides. For example, the rigid circuit board 220 comprises a first side, a second side, a third side, and a fourth side. When there are a plurality of light-emitting elements 230, at least one light-emitting element is disposed in each of the sides of the rigid circuit board 220.

In one embodiment, the outer sleeve 260 may be integrally formed or comprise sub-sleeves. For example, the outer sleeve 260 comprises two sub-sleeves, which are a first sleeve 261 and a second sleeve 262. The first sleeve 261 is sleeved on the rigid circuit board 220 from a first end of the rigid circuit board 220. Specifically, the first sleeve 261 defines a through hole 263. The first sleeve 261 is sleeved on the rigid circuit board 220 through the first power connecting plug 210A. The first power connecting plug 210A passes through the through hole 263 and is exposed outside the first sleeve 261. The second sleeve 262 is sleeved on the rigid circuit board 220 from a second end of the rigid circuit board 220. Specifically, the second sleeve 262 defines a through hole. The second outer sleeve 262 is sleeved on the rigid circuit board 220 through the second power connecting plug 210B. The second power connecting plug 210B passes through the through hole of the second sleeve 262 and is exposed outside the second sleeve 262. The through hole of the second sleeve 262 may refer to the through hole 263, which is not described in detail. When the first sleeve 261 and the second sleeve 262 are sleeved on the rigid circuit board 220, the first sleeve 261 and the second sleeve 262 are sleeved with each other or are abutted against each other.

As shown in FIGS. 27-34, 35A, 35B, 38A and 38B, the lamp (10A, 10B, 10C, 10D, 10E, 10F, 10G, 10H, 10I, 10J) comprises at least one wiring terminal 100, at least one light-emitting body 200, and at least one lampshade 300. Each wiring terminal 100 including one terminal body and one power connecting port may refer to the wiring terminal (100A, 100B, 100C, 100D, 100E, 100F, 100I). Each wiring terminal 100 including two terminal bodies and two electrically connected power connecting ports may refer to the wiring terminal (100G, 100H), which is not repeatedly described herein.

As shown in FIG. 27, the lamp 10A comprises wiring terminals 100, light-emitting bodies 200 and lampshades 300. Each of the wiring terminals 100 disposed between two adjacent lampshades 300 may refer to the wiring terminal 100G. A last wiring terminal 100 disposed on a tail end of the lamp 10A may refer to the wiring terminal (100A, 100B, 100C, 100D, 100E, 100F, 100I). Each of the light-emitting bodies 200 may refer to the light-emitting body (200B, 200C, 200D). Each of the power connecting plugs of each of the light-emitting bodies 200 and the power connecting port of a corresponding wiring terminal 100 are plugged into each other to achieve electrical connection therebetween. Specifically, each of the lampshades 300 are connected to corresponding two wiring terminals 100, and each of the lampshades 300 are screwed with outer threads of two terminal bodies off the corresponding two wiring terminals 100. The number of lampshades 300 shown in FIG. 27 is not limited to three and is freely determined according to needs, which is not limited thereto. Two ends of the lamp 10A shown in FIG. 27 are configured to be connected to corresponding components or positions according to requirements. The wiring terminals 100 shown in FIG. 27 are connected and communicated through the wires.

As shown in FIG. 28, the lamp 10B comprises wiring terminals 100, light-emitting bodies 200, and lampshades 300. Each of the wiring terminals 100 disposed between two adjacent lampshades 300 may refer to the wiring terminal 100G. A last wiring terminal 100 disposed on a tail end of the lamp 10B may refer to the wiring terminal (100A, 100B, 100C, 100D, 100E, 100F, 100I). Each of the light-emitting bodies 200 connected to corresponding two wiring terminals 100 may refer to the light-emitting body (200B, 200C, 200D). Each of the power connecting plugs of each of the light-emitting bodies (200B, 200C, 200D) and the power connecting port of a corresponding wiring terminal 100 are plugged into each other to achieve electrical connection therebetween. A last light-emitting body 200 may refer to the light-emitting body 200A. The power connecting plug of the last light-emitting body 200 is connected to the terminal body of a corresponding wiring terminal. Specifically, each of the lampshades 300 except for the last lampshade is screwed with corresponding two wiring terminals 100. The last lampshade is screwed with a corresponding wiring terminal. The number of lampshades 300 shown in FIG. 28 is not limited to three and is freely determined according to needs, which is not limited thereto. The wiring terminals 100 shown in FIG. 28 are connected and communicated through the wires. One end of the wires of the lamp 10B shown in FIG. 28 is connected to a corresponding component or a corresponding position according to requirements.

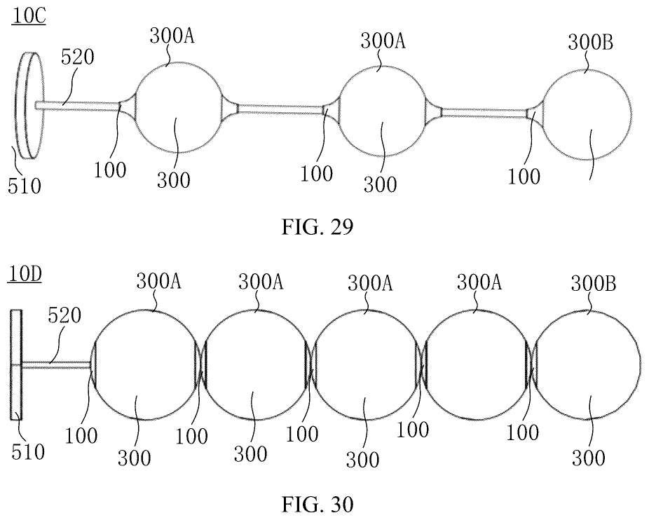

As shown in FIG. 29, the lamp 10C comprises wiring terminals 100, light-emitting bodies 200, and lampshades 300. Each of the wiring terminals 100 disposed between two adjacent lampshades 300 may refer to the wiring terminal 100G. A last wiring terminal 100 disposed on a tail end of the lamp 10C may refer to the wiring terminal (100A, 100B, 100C, 100D, 100E, 100F, 100I). Each of the light-emitting bodies 200 connected to corresponding two wiring terminals 100 may refer to the light-emitting body (200B, 200C, 200D). Each of the power connecting plugs of each of the light-emitting bodies (200B, 200C, 200D) and the power connecting port of a corresponding wiring terminal 100 are plugged into each other to achieve electrical connection therebetween. A last light-emitting body 200 may refer to the light-emitting body 200A. The power connecting plug of the last light-emitting body 200 is connected to the terminal body of a corresponding wiring terminal. Specifically, each of the lampshades 300 except for the last lampshade 300 is screwed with corresponding two wiring terminals 100. The last lampshade 300 is screwed with a corresponding wiring terminal. Further, the wiring terminal connected to a first lampshade 200 is connected to a base 510 through a support rod 520. The base 510 is able to be placed at a desired location such as on the floor. The base 510 and the support rod 520 jointly support the light-emitting bodies, the lampshades 300, and the wiring terminals 100. It should be noted that electrical components such as a control circuit board and the battery are installed in the base 510, and the power connecting port of one of the wiring terminals 100 is electrically connected to the control circuit board and the battery installed in the base 510 by passing through a conductive line through the support rod 520. The number of the lampshades 300 shown in FIG. 29 is not limited to three and is freely determined according to needs, which is not limited thereto. The wiring terminals 100 shown in FIG. 29 are connected and communicated through the wires.

As shown in FIG. 30, the difference between the lamp 10D and the lamp 10C is that each of the wiring terminals 100 in the lamp 10D refers to the wiring terminal 100H shown in FIG. 14, and other parts of the lamp 10D are the same as those in the lamp 10C, which are not described in detail herein.

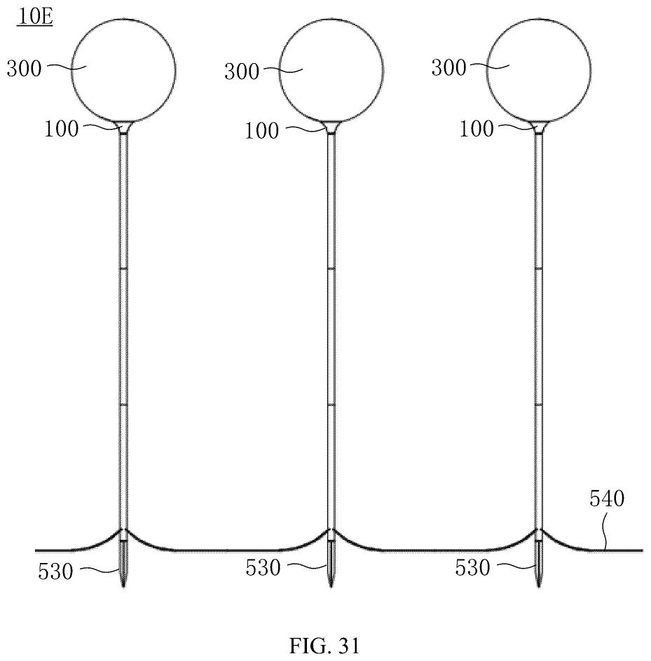

As shown in FIG. 31, the lamp 10E comprises wiring terminals 100, light-emitting bodies, and lampshades 300. Each of the lampshades 300 is screwed with the terminal body of a corresponding wiring terminal 100. The power connecting port of each of the wiring terminals 100 and the power connecting plug of a corresponding light-emitting body are plugged into each other to achieve electrical connection therebetween. Each of the wiring terminals 100 is physically connected to a corresponding one of mounting components 530, and the wiring terminals 100 are electrically connected through the wire 540. The mounting components 530 are installed at a desired location, such as being inserted into the ground, or hung in the air. Each of the wiring terminals 100 may refer to the wiring terminal (100A, 100B, 100C, 100D, 100E, 100F, 100I), and each of the light-emitting bodies 200 may refer to the light-emitting body 200A. The mounting components 530 are physically connected to the wires 540. Specifically, the mounting components 530 are connected to different positions of the wire 540 to facilitate the electrical connection of the wiring terminals 100 with the wire 540. The number of the lampshades 300, the number of the light-emitting bodies, and the number of the wiring terminals 100 are not limited to that shown in FIG. 31 and are determined according to the requirements, which are not limited thereto.

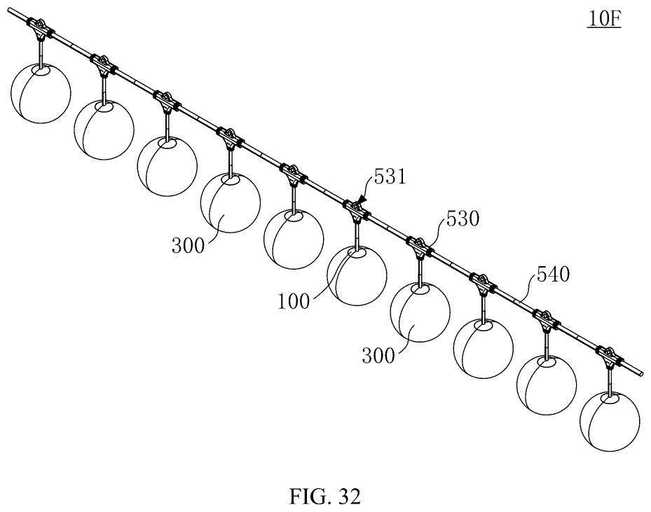

As shown in FIG. 32, the lamp 10F is different from the lamp 10E. Specifically, the mounting components 530 of the lamp 10F comprise hanging structures 531. Each of the hanging structures 531 may be one of a through hole, a groove, a hook, etc. The hanging structures 531 are configured to hang the lamp 10F at a desired position, such as a wall, a wall top, a Christmas tree, etc. Similarly, each of the wiring terminals 100 of the lamp 10F is physically connected to the corresponding one of the mounting components 530, and the wiring terminals 100 are electrically connected to the wire 540. The mounting components 530 are connected to different positions of the wire 540, so that the wiring terminals 100 are electrically connected to the wire 540. For example, the mounting components 530 are roughly T-shaped, and the wire 540 passes through an upper end of each of the mounting components 530. A lower end of each of the mounting components 530 is connected to a corresponding one of the wiring terminals 100. Other components of the lamp 10F may refer to those of the lamp 10E, which are not repeatedly described herein. The number of the lampshades 300, the number of the light-emitting bodies, and the number of the wiring terminals 100 are not limited to that shown in FIG. 32 and are freely determined according to the requirements, which are not limited thereto.

The lamp shown in FIGS. 27-32 is also called a lamp string. That is, the lampshades and the light-emitting bodies in the lamp shown in FIGS. 27-32 are disposed in a string.

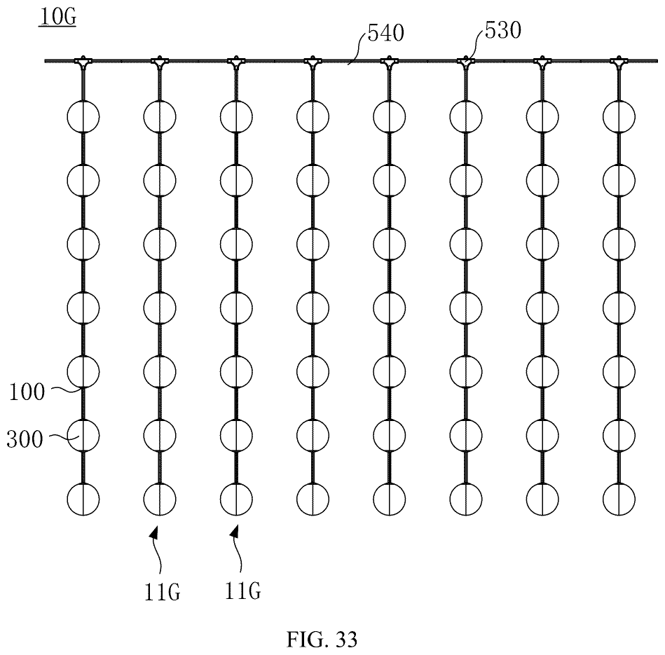

As shown in FIG. 33, the lamp 10G comprises lamp strings 11G, and each of the lamp strings 11G comprises the light-emitting bodies, the lampshades 300, and the wiring terminals 100. Each of the lamp strings 11G is physically connected to a corresponding one of the mounting components 530, and the lamp strings 11G are electrically connected to the wire 540. The mounting components 530 and the wire 540 may refer to the mounting components 530 and the wire 540 shown in FIG. 32, and are not repeatedly described herein. It should be noted that when each of the lamp strings 11G shown in FIG. 33 comprises only one light-emitting body, one lampshade 300 and one wiring terminal 100, the lamp 10G is equivalent to the lamp 10F shown in FIG. 32. In the embodiment, each of the lamp strings 11G may have the connection relationship between the the light-emitting bodies, the lampshades, and the wiring terminals as that in FIG. 27 or FIG. 28. In other optional methods, each of the light strings 11G may have the connection relationship between the light-emitting bodies, the lampshades, and the wiring terminals shown in FIG. 29.

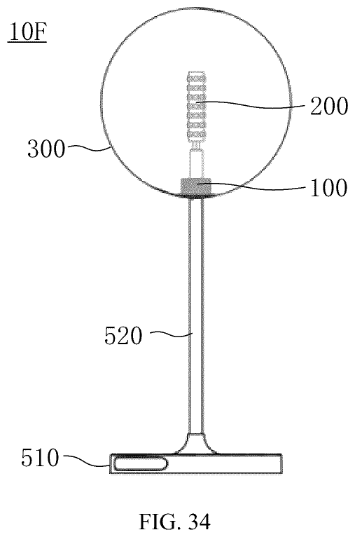

As shown in FIG. 34, the lamp 10F comprises one wiring terminal 100, one light-emitting body 200, and one lampshade 300. The lampshade 300 is screwed with the terminal body of the wiring terminal 100. The power connecting port of the wiring terminal 100 and the power connecting plug of the light-emitting body 200 are plugged into each other to realize electrical connection therebetween. The wiring terminal 100 is physically connected to the support rod 520. The wiring terminal 100 is connected to the base 510 through the support rod 520. The base 510 is placed in a desired position such as being placed on the floor or on the desktop. The base 510 and the support rod 520 jointly support the light-emitting body 200, the lampshade 300, and the wiring terminal 100. It should be noted that the electrical components, such as the control circuit board and the battery, are installed in the base 510, and the power connecting port of the wiring terminal 100 is electrically connected to the control circuit board and the battery installed in the base 510 through the wire passing through the support rod 520. The wiring terminal 100 may refer to the wiring terminals (100A, 100B, 100C, 100D, 100E, 100F, 100I), and the light-emitting body may refer to the light-emitting body 200A.

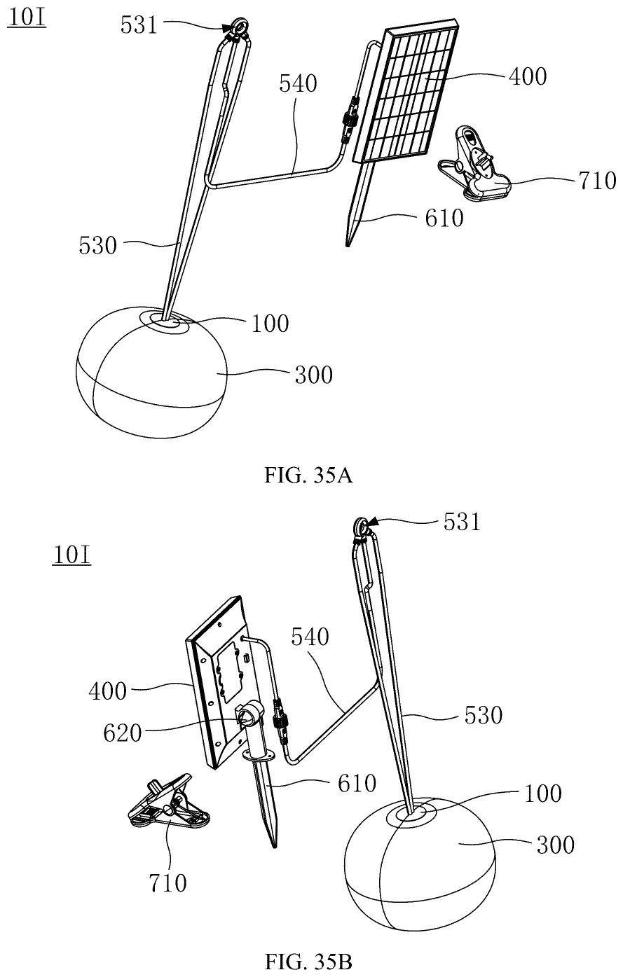

As shown in FIGS. 35A and 35B, the lamp 10I comprises one wiring terminal 100, one light-emitting body, and one lampshade 300. The lampshade 300 is screwed with the terminal body of the wiring terminal 100. The power connecting port of the wiring terminal 100 and the power connecting plug of the light-emitting body are plugged into each other to achieve electrical connection therebetween. The wiring terminal 100 is physically connected to a mounting component 530, and the wiring terminal 100 is electrically connected to the wire 540. The mounting component 530 is installed at the desired location, such as being inserted into the ground or hung at a high place. Specifically, the mounting component 530 comprises a hanging structure 531, and the hanging structure 531 is one of a through hole, a groove, a hook, etc. The wire 540 is electrically connected to the solar panel 400, and the solar panel 400 is connected to a fixing component 610. The solar panel 400 is rotatable relative to the fixing component 610. Specifically, a rotating shaft 620 is connected between a rear side of the solar panel 400 and the fixing component 610, and the solar panel 400 is rotatable relative to the fixing component 610 around the rotating shaft 620, thereby adjusting a direction of a front side of the solar panel 400. Specifically, the hanging structure 531 is fixed to a clamp 710, and the clamp 710 is clamped to a predetermined position to hang the lampshade 300. The wiring terminal 100 may refer to the wiring terminal (100A, 100B, 100C, 100D, 100E, 100F, 100I), and the light-emitting body may refer to the light-emitting body 200A.

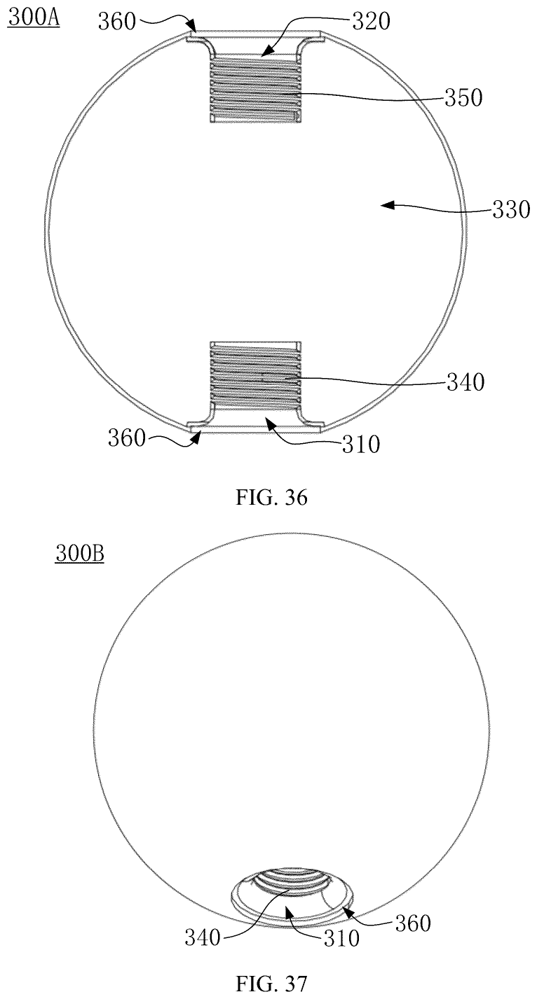

In some embodiments, each of the lampshades of the lamps of the present disclosure is screwed with at least two terminal bodies, so that each of the lampshades 300 has at least two openings. The present disclosure takes one lampshade as an example for further illustration. As shown in FIG. 36, the lampshade 300A comprises a first opening 310, a second opening 320, and an accommodating cavity 330. The first opening 310 and the second opening 320 are communicated with the accommodating cavity 330. The lampshade 300A further comprises a first inner thread 340 and a second inner thread 350. The first inner thread 340 is disposed at the first opening 310, and the second inner thread 350 is disposed at the second opening 320. The first inner thread 340 is detachably connected to the outer thread of the terminal body. The outer thread of the terminal body may refer to the outer thread 111 or the first outer thread 111A of the wiring terminal in the above embodiments. The light-emitting body 200 is able to be placed in the accommodating cavity 330 from the first opening 310 or the second opening 320 and is able to be taken out from the accommodating cavity 330 through the first opening 310 or the second opening 320. The light-emitting body 200 may refer to the light-emitting body 200B, the light-emitting body 200C, or the light-emitting body 200D. The lampshade 300A further comprises a first waterproof groove 360 communicated with the first opening 310 and a second waterproof groove 360 communicated with the second opening 320. Each of the waterproof grooves 360 are configured to place the sealing structure 115 of the corresponding wiring terminal 100 to increase the connection stability and sealing of the corresponding wiring terminal 100 and the lampshade 300A.

At least one lampshade 300 in the lamp of the present disclosure is screwed with the terminal body of one wiring terminal 100, so that the lampshade 300 comprises only one opening. Specifically, as shown in FIG. 37, the lampshade 300B comprises the first opening 310 and the accommodating cavity 330, and the first opening 310 is communicated with the accommodating cavity 330. The lampshade 300B further comprises the first inner thread 340, and the first inner thread 340 surrounds the first opening 310. The first inner thread 340 is detachably connected to the outer thread of the terminal body. The outer thread of the terminal body may refer to the outer thread 111 or the first outer thread 111A of the wiring terminal in the above embodiments. The light-emitting body 200 is able to be placed in the accommodating cavity 330 from the first opening 310 and is able to be taken out of the accommodating cavity 330 through the first opening 310. The light-emitting body 200 may refer to the light-emitting body 200A. A position of lampshade 300B opposite to the first opening 310 is closed. The lampshade 300B further comprises a waterproof groove 360 communicated with the first opening 310. The waterproof groove 360 is configured to place the sealing structure 115 of the wiring terminal 100 to increase the connection stability and sealing between the wiring terminal 100 and the lampshade 300B.

Each of the lampshades 300 in FIG. 27 comprises at least two openings, so each of the lampshades 300 in FIG. 27 may refer to the lampshade 300A shown in FIG. 36. The last lampshade 300 shown in FIGS. 28-30 comprise only one opening, which may refer to the lampshade 300A shown in FIG. 37. The other lampshades 300 shown in FIGS. 28-30 may refer to the lampshade 300A shown in FIG. 36. The lampshade 300 shown in FIGS. 31, 32, 34 and 25 comprise only one opening, and the position opposite to the opening is closed, so the lampshade 300 may refer to the lampshade 300B shown in FIG. 37. Some lampshades 300 in FIG. 33 have at least two openings, and some lampshades 300 have one opening.

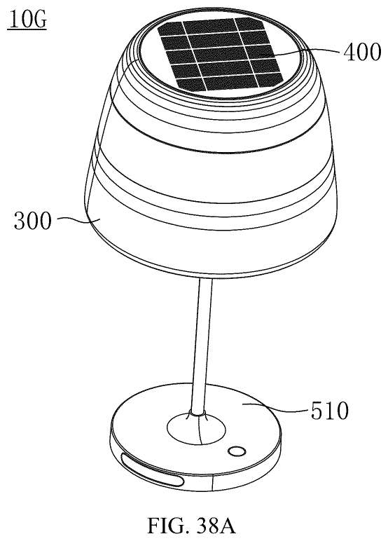

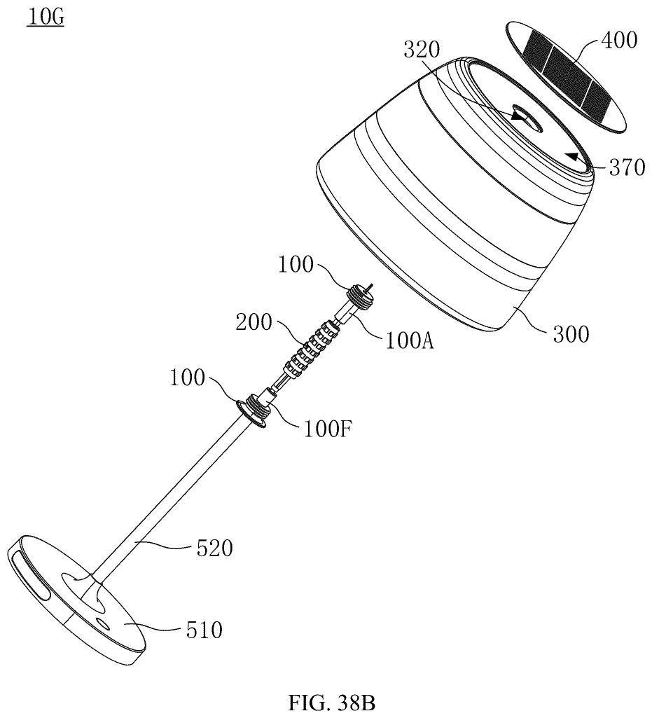

It should be noted that the structure of the lampshade 300 is not limited thereto, and the electrical components of the lamp are not limited thereto. As shown in FIGS. 38A and 38B, the lamp 10J comprises a solar panel 400, a light-emitting body 200, two wiring terminals 100, and a lampshade 300. A first wiring terminal 100 thereof may refer to wiring terminal (100A, 100B, 100I), and the present disclosure takes the wiring terminal 100A as an example; A second wiring terminal 100 thereof may refer to the wiring terminal (100A, 100B, 100C, 100D, 100E, 100F, 100I) and the present disclosure takes the wiring terminal 100F as an example. The light-emitting body 200 may refer to light-emitting bodies (200B, 200C, 200D), and the present disclosure takes light-emitting body 200B as an example.

As shown in FIGS. 38A and 38B, the lampshade 300 comprises two openings, which are respectively a first opening and a second opening 320. The first opening may refer to the first opening 310 in FIG. 36 or FIG. 37. The lampshade 300 comprises a first inner thread and a second inner thread. The first inner thread and the second inner thread may refer to the first inner thread 340 and the second inner thread 350 in FIG. 26. A difference between the lampshade 300 and the lampshade 300B in the lamp 10G is that a mounting groove 370 is defined on a top portion of the lampshade 300. The mounting groove 370 is communicated with the second opening 320, the solar panel 400 is installed in the mounting groove 370, and a portion of the solar panel 400 is disposed corresponding to the second opening 320. A first power connecting port of the wiring terminal 100A is plugged into the first power connecting plug of the light-emitting body 200, and the at least two electrical connectors of the two are electrically connected. The at least two electrical connectors of the second power connecting port of the wiring terminal 100A, such as the two electrical connectors, are electrically connected to the solar panel 400 through a wire passing through the second opening 320, and the terminal body of the wiring terminal 100A is connected to the second inner thread. The first power connecting port of the second wiring terminal 100F is plugged into the second power connecting plug of the light-emitting body 200, and the electrical connectors thereof are electrically connected. The terminal body of the second wiring terminal 100F is connected to the first inner thread.

Furthermore, the wiring terminal 100F is connected to the support rod 520, and the support rod 520 is connected to the base 510. The support rod 520 and the base 510 may refer to the lamp 10F in FIG. 34, which are not depicted in detail herein.

In other optional embodiments, the light-emitting body 200 in the lamp 10J is directly electrically connected to the solar panel 400 through a wire, instead of being electrically connected to the solar panel 400 through the wiring terminal 100.

In the embodiments of the lamp (10A, 10B, 10C, 10D, 10E, 10F, 10G, 10H, 10I, 10J), any power connecting plug of any light-emitting body 200 and any power connecting port of any wiring terminal 100 are allowed to be plugged in and out of each other. Taking one light-emitting body 200 and one wiring terminal as an example, when the first/second power connecting plug of the light-emitting body 200 and the power connecting port of the wiring terminal 100 are plugged into each other, the at least two electrical connectors of the first/second power connecting plug are electrically connected to the at least two electrical connectors of the power connecting port of the wiring terminal 100.

In the embodiments of the above lamp (10A, 10B, 10C, 10D, 10E, 10F, 10G, 10H, 10I, 10J), at least two electrical connectors of the power connecting port of each of the wiring terminals 100 are rotatable around the second axis; and/or the at least two electrical connectors of each power connecting plug of each of the light-emitting body 200 are rotatable around the third axis. The second axis may refer to the second axis L2, and the third axis may refer to the third axis L3. The second axis L2 and/or the third axis L3 are parallel to the first axis L1.

In the embodiments of the above lamp (10A, 10B, 10C, 10D, 10E, 10F, 10G, 10H, 10I, 10J), during the process of plugging the power connecting port of each wiring terminal 100 and the power connecting plug of a corresponding light-emitting body 200 and/or after the power connecting port of each wiring terminal 100 and the power connecting plug of the corresponding light-emitting body 200 are plugged into each other, the power connecting port of each wiring terminal 100 and the power connecting plug of the corresponding light-emitting body 200 mutually rotate, rotate relative to each other, or rotate together.

In the embodiments of the above lamp (10A, 10B, 10C, 10D, 10E, 10F, 10G, 10H, 10I, 10J), during the connection process between the outer thread of each wiring terminal 100 and the first inner thread 340, the terminal body of each wiring terminal 100 and a corresponding lampshade 300 rotate relative to each other or mutually rotate, and the power connecting port of each wiring terminal 100 and the power connecting plug of the corresponding light-emitting body 200 mutually rotate, rotate relative to each other, or rotate together, and are plugged into each other.

In the embodiments of the above lamp (10A, 10B, 10C, 10D, 10E, 10F, 10G, 10H, 10I, 10J), after the outer thread of each wiring terminal 100 is screwed with the corresponding first inner thread 340, the terminal body of each wiring terminal 100 seals the corresponding first opening 310, and the at least two electrical connectors of each wiring terminal 100 and the at least two electrical connectors of the power connecting plug of the corresponding light-emitting body 200 are electrically connected.

In the embodiments of the above lamp (10A, 10B, 10C, 10D, 10E, 10F, 10G, 10H, 10I, 10J), the terminal body and the power connecting port of each wiring terminal 100 are rotatable together around the first axis L1. For example, the outer thread of each wiring terminal 100, the first inner thread 340 of the corresponding lampshade, the at least two electrical connectors of the power connecting plug of the corresponding light-emitting body 200, and the at least two electrical connectors of the power connecting port are rotatable around the first axis L1.

In the embodiments of the above lamp (10A, 10B, 10C, 10D, 10E, 10F, 10G, 10H, 10I, 10J), during the connection process of the outer thread of the terminal body of each wiring terminal 100 and the inner thread (such as the first inner thread 340) of the corresponding lampshade 300, the power connecting port of each wiring terminal 100 and the corresponding light-emitting body 200 of the lamp mutually rotate, rotate relative to each other, or rotate together, and are plugged into each other; the outer thread of the terminal body of each wiring terminal 100 is screwed with the first inner thread of the corresponding lampshade 300; and the at least two electrical connectors of the power connecting port are electrically connected to the at least two electrical connectors of the power connecting plug of the corresponding light-emitting body 200.

In the embodiments of the above lamps (10A, 10B, 10C, 10D, 10G), for one of the lampshade 300 connected to two wiring terminals, the first terminal body of the first wiring terminal 100 is connected to the lampshade 300 before the second terminal body of the second wiring terminal 100 is connected to the lampshade. The first terminal body of the first wiring terminal 100 is electrically connected to the light-emitting body in the lampshade. That is, the first terminal body is connected to the as at least two electrical connectors of the first power connecting plug of the light-emitting body 200 in the lampshade 300 before the second terminal body of the second wiring terminal 100 is connected to the second power connecting plug of the light-emitting body 200. During the connection process of the outer thread of the first terminal body of the first wiring terminal 100 with the first inner thread 340 of the lampshade 300, the first power connecting port of the first wiring terminal 100 rotates together with the light-emitting body 200 in the lampshade. During the connection process of the outer thread of the second terminal body of the second wiring terminal 100 with the second inner thread 350 of the lampshade, the second power connecting port of the second wiring terminal 100 and the light-emitting body 200 in the lampshade mutually rotate, rotate relative to each other, or rotate together. After the outer thread of the second terminal body of the second wiring terminal 100 is completely screwed with the second inner thread 350 of the lampshade 300, the at least two electrical connectors of the first power connecting port of the first wiring terminal 100 and the at least two electrical connectors of the second power connecting port of the second wiring terminal 100 are electrically connected to the light-emitting body 200 to form an electrical circuit.

Alternatively, in the embodiments of the above lamps (10A, 10B, 10C, 10D, 10G), for one of the lampshade 300 connected to two wiring terminals, the second terminal body of the second wiring terminal 100 is connected to the lampshade 300 before the first terminal body of the first wiring terminal 100 is connected to the lampshade, and the first terminal body of the first wiring terminal 100 is electrically connected to the light-emitting body 200 before the second terminal body of the second wiring terminal 100 is electrically connected to the light-emitting body 200. During the connection process between the first outer thread of the first terminal body of the first wiring terminal 100 and the first inner thread 340 of the lampshade 300, there is a situation where the first power connecting port of the first wiring terminal 100 rotates together with the light-emitting body 200, and there is a situation where the second power connecting port of the second wiring terminal 100 and the light-emitting body 200 mutually rotate, rotate relative to each other, or rotate together. When the first outer thread of the first terminal body of the first wiring terminal 100 is completely connected to the first inner thread 340 of the lampshade 300, the at least two electrical connectors of the first power connecting port of the first wiring terminal 100 and the at least two electrical connectors of the second power connecting port of the second wiring terminal 100 are electrically connected to the light-emitting body 200 to form the electrical circuit.

In the embodiments of the above lamp (10A, 10B, 10C, 10D, 10G), during the connection process between the outer thread of the first terminal body of each first wiring terminal 100 and the first inner thread 340 of the corresponding lampshade300, the first power connecting port of the first wiring terminal 100 and the light-emitting body 200 of the corresponding lampshade first rotate together and then mutually rotate, or rotate relative to each other.

An assembling process of the lamp is illustrated in the following embodiments.

Taking one lampshade 300 as an example, the assembling process comprises steps S11-S13.

The step S11 comprises mounting the light-emitting body to a first wiring terminal 100.

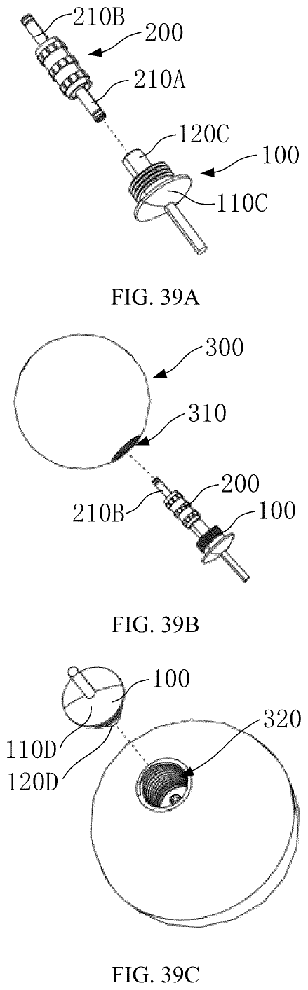

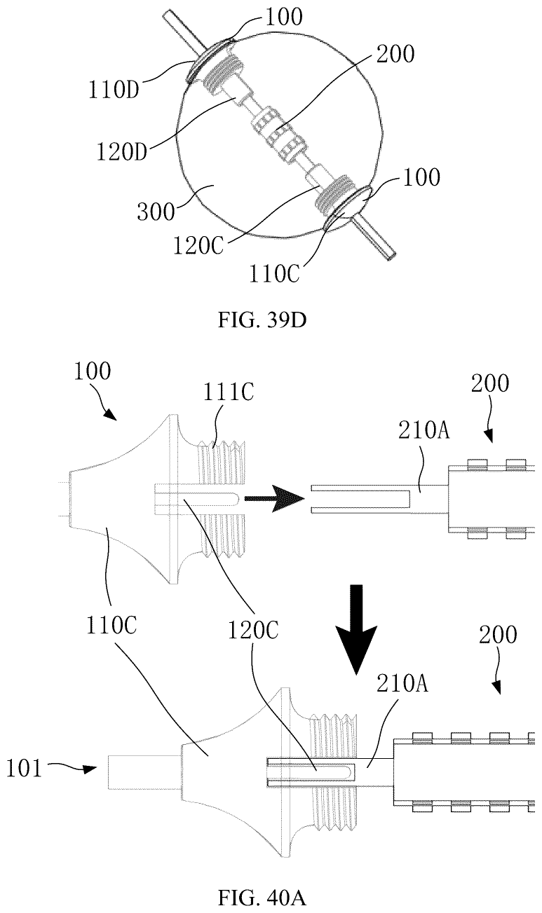

Specifically, as shown in FIG. 39A, the first power connecting port 120C of the first wiring terminal 100 and the first power connecting plug 210A of the light-emitting body 200 are plugged into each other, so that the at least two electrical connectors of the first power connecting port 120C are connected to the at least two electrical connectors of the first power connecting plug 210A. The first power connecting port 120C and the first power connecting plug 210A rotate with each other or rotate together during the mutual plugging process. After the first power connecting port 120C and the first power connecting plug 210A are plugged into each other, they mutually rotate, rotate relative to each other, or rotate together.

The step S12 comprises connecting the first wiring terminal to the lampshade.

Specifically, as shown in FIG. 39B, the second power connecting plug 200B of the light-emitting body 200 is inserted into the accommodating cavity 330 from the first opening 310 until the first terminal body 110C of the first wiring terminal 100 contacts the lampshade 300. Then, the first terminal body 110C is driven to rotate relative to the lampshade 300 to connect the first outer thread of the first terminal body 110C with the first inner thread of the lampshade 300. During the connection process of the first outer thread of the first terminal body 110C and the first inner thread of the lampshade 300 (in other words, during the rotation process of the first terminal body 110C relative to the lampshade 300), the first terminal body 110C, the first power connecting port 120C, and the light-emitting body 200 rotate together.

The step S13 comprises physically connecting the second wiring terminal 100 to the lampshade 300 to enable the second wiring terminal 100 being electrically connected to the light-emitting body 200.

Specifically, as shown in FIG. 39B, the second power connecting port 120D and the second terminal body 110D of the second wiring terminal 100 are aligned with the second opening 320 of the lampshade 300; then the second outer thread of the second terminal body 110D of the second wiring terminal 100 is screwed with the second inner thread of the lampshade 300. At the same time, the second power connecting port 120D of the second wiring terminal 100 is plugged into the second power connecting plug 210B of the light-emitting body 200 from the second opening 320. Finally, the second terminal body 110D is driven to rotate relative to the lampshade 300 to completely screw with the second inner thread of the lampshade 300, and at the same time, the at least two electrical connectors of the second power connecting port 120D are electrically connected to the at least two electrical connectors of the second power connecting plug 210D. A complete structure of the two wiring terminals 100, the light-emitting body 200 and the lampshade 300 is obtained, which is shown in FIG. 39D.

In the embodiment, during the connection process between the second outer thread of the second terminal body 110D of the second wiring terminal 100 and the second inner thread of the lampshade 300, the second power connecting port 120D of the second wiring terminal 100 and the light-emitting body 200 of the lamp mutually rotate, rotate relative to each other, or rotate together. The second outer thread of the second terminal body 110D of the second wiring terminal 100 is connected to the second inner thread of the lampshade 300, and the at least two electrical connectors of the first power connecting port 120C of the first wiring terminal 100 and the at least two electrical connectors of the second power connecting port 120D of the second wiring terminal 100 are electrically connected to the light-emitting body 200 to form the electrical circuit.

In the case where the lamp only comprises one wiring terminal 100, one light-emitting body 200 and one lampshade, an assembling process thereof may refer to the steps S11 and S12, which are not repeatedly described herein.

It should be noted that, in a case that at least two wiring terminals 100 are installed on the same lampshade 300, during an actual assembling process of the lamp, the light-emitting body 200 may have a longer length or be disposed at a predetermined angle, and a distance between the two openings of the lampshade may be set to be long or short, which affect the efficiency and accuracy of the assembly of the lamp. The following introduces two embodiments as examples.

In one embodiment, an assembling process where the length of the light-emitting body is not less than the distance between the two openings of the lampshade is provided. The assembling process comprises steps S21-S23.

The step S21 comprises mounting the light-emitting body to the first wiring terminal 100.

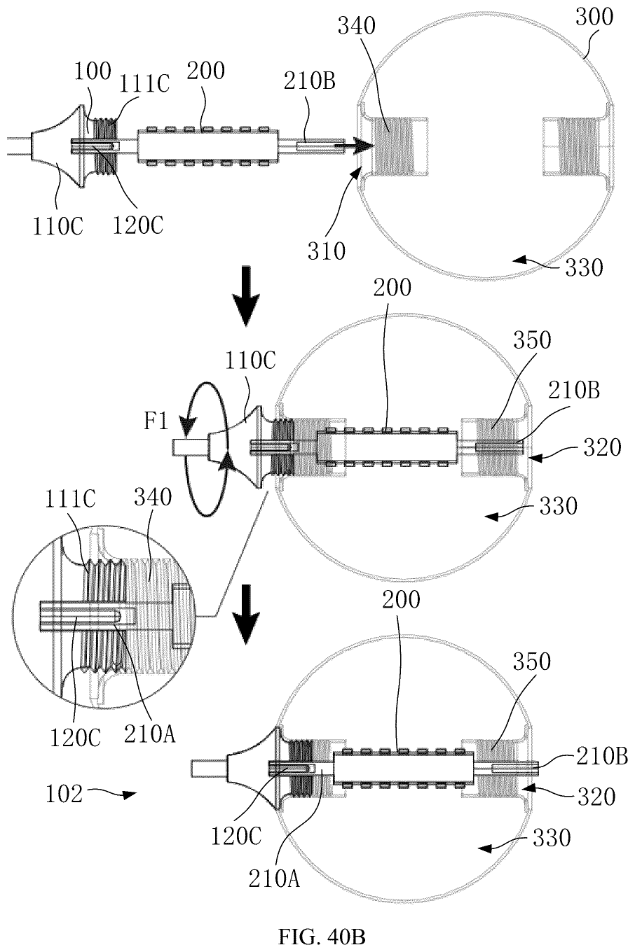

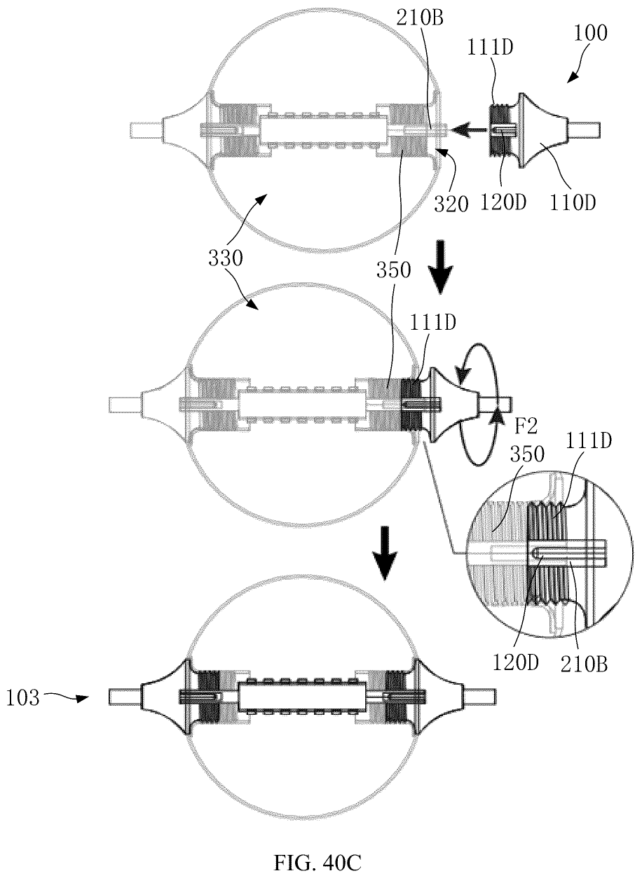

Specifically, as shown in FIG. 40A, the first power connecting port 120C of the first wiring terminal 100 is aligned with the first power connecting plug 210A of the light-emitting body 200, then the first power connecting port 120C of the first wiring terminal 100 and the first power connecting plug 210A of the light-emitting body 200 are plugged into each other until the first power connecting port 120C and the first power connecting plug 210A are completely plugged together without a gap, thereby obtaining a first assembling body 101. At this time, the least two electrical connectors of the first power connecting port 120C are physically and electrically connected to the at least two electrical connectors of the first power connecting plug 210A. The first power connecting port 120C and the first power connecting plug 210A mutually rotate, rotate relative to each other, or rotate together during the mutual plugging process. After the first power connecting port 120C is completely connected to the first power connecting plug 210A, the first power connecting port 120C and the first power connecting plug 210A mutually rotate, rotate relative to each other, or rotate together.

The step S22 comprises connecting the first wiring terminal to the lampshade 300.

Specifically, as shown in FIG. 40B, the second power connecting plug 210B of the light-emitting body 200 is aligned with the first opening 310 of the lampshade 300. Then, the second power connecting plug 210B of the light-emitting body 200, the one or more light-emitting elements and a portion of the first power connecting plug 210A are inserted into the accommodating cavity 330 until the first terminal body 110C of the first wiring terminal 100 contacts the lampshade 300. The first terminal body 110C is driven to rotate relative to the lampshade 300 along the first direction F1 to connect the first outer thread 111C of the first terminal body 110C with the first inner thread 340 of the lampshade 300 until the first outer thread 111C is completely screwed with the first inner thread 340, thereby obtaining a second assembling body 102. During the connection process of the first outer thread 111C of the first terminal body 110C and the first inner thread 340 of the lampshade 300 (in other words, the process of the first terminal body 110C rotating relative to the lampshade 300 along the first direction F1), the first terminal body 110C, the first power connecting port 120C, and the light-emitting body 200 rotate together.

In the second assembling body 102, at least a portion of the second power connecting plug 210B is disposed at the second opening 320. In some cases, a portion of the second power connecting plug 210B extends from the second opening 320 to the outside of the lampshade 300. In other cases, one end of the second power connecting plug 210B away from the one or more light-emitting elements is flush with an edge of the lampshade 300.

The step S23 comprises physically connecting the second wiring terminal 100 to the lampshade 300 to enable the second wiring terminal 100 being electrically connected to the light-emitting body 200.

Specifically, as shown in FIG. 40C, the second power connecting port 120D of the second wiring terminal 100 is aligned with the second power connecting plug 210B located at the second opening 320 of the lampshade 300, and the second terminal body 110D of the second wiring terminal 100 is also aligned with the second opening 320 of the lampshade 300. Then, the second outer thread 111D of the second terminal body 110D of the second wiring terminal 100 is connected to the second inner thread 350 of the lampshade 300. At the same time, the second power connecting port 120D of the second wiring terminal 100 is plugged into the second power connecting plug 210B of the light-emitting body 200 from the second opening 320. Finally, the second terminal body 110D is driven to rotate relative to the lampshade 300 in a second direction F2 to completely connect the second outer thread 111D of the second terminal body 110D with the second inner thread 350 of the lampshade 300. At the same time, the at least two electrical connectors of the second power connecting port 120D are electrically connected to the at least two electrical connectors of the second power connecting plug 210D, thereby obtaining a third assembling body 103. The third assembling body 103 is a completely structure in which the two wiring terminals 100, the light-emitting body 200 and the lampshade 300 are assembled together.

In the embodiment, during the connection process between the second outer thread 111D of the second terminal body 110D of the second wiring terminal 100 and the second inner thread 350 of the lampshade 300, the second power connecting port 120D of the second wiring terminal 100 and the light-emitting body 200 mutually rotate, rotate relative to each other, or rotate together. The second outer thread 111D of the second terminal body 110D of the second wiring terminal 100 is screwed with the second inner thread 350 of the lampshade 300, and the at least two electrical connectors of the first power connecting port 120C of the first wiring terminal 100 and the at least two electrical connectors of the second power connecting port 120D of the second wiring terminal 100 are electrically connected to the light-emitting body 200 to form the electrical circuit.

In one embodiment, an assembling process where the length of the light-emitting body is less than the distance between the two openings of the lampshade is provided. The assembling process comprises steps S31-S33.

The step S31 comprises mounting the light-emitting body to the first wiring terminal 100.

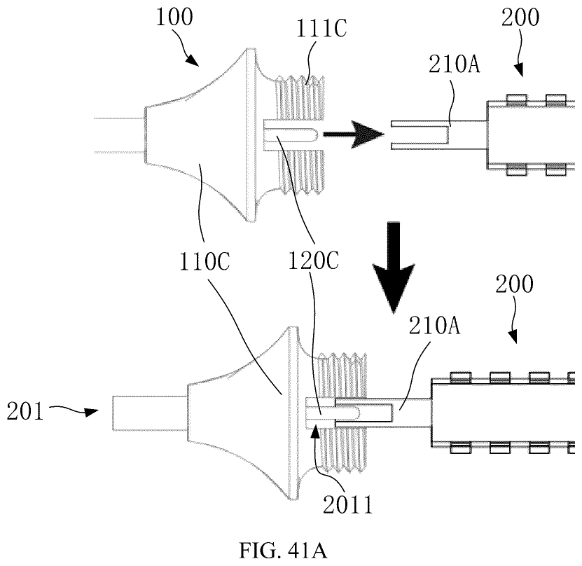

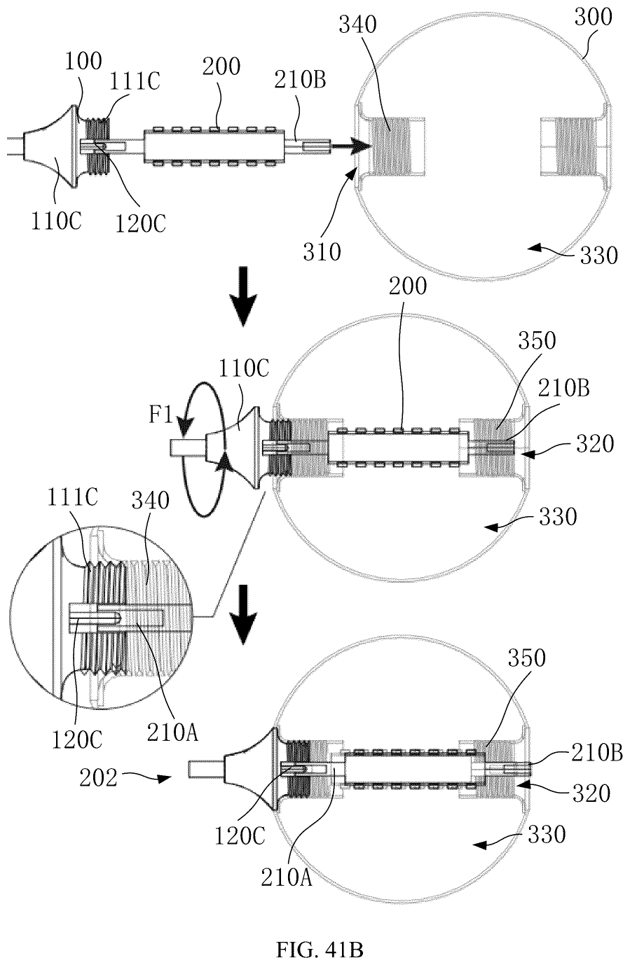

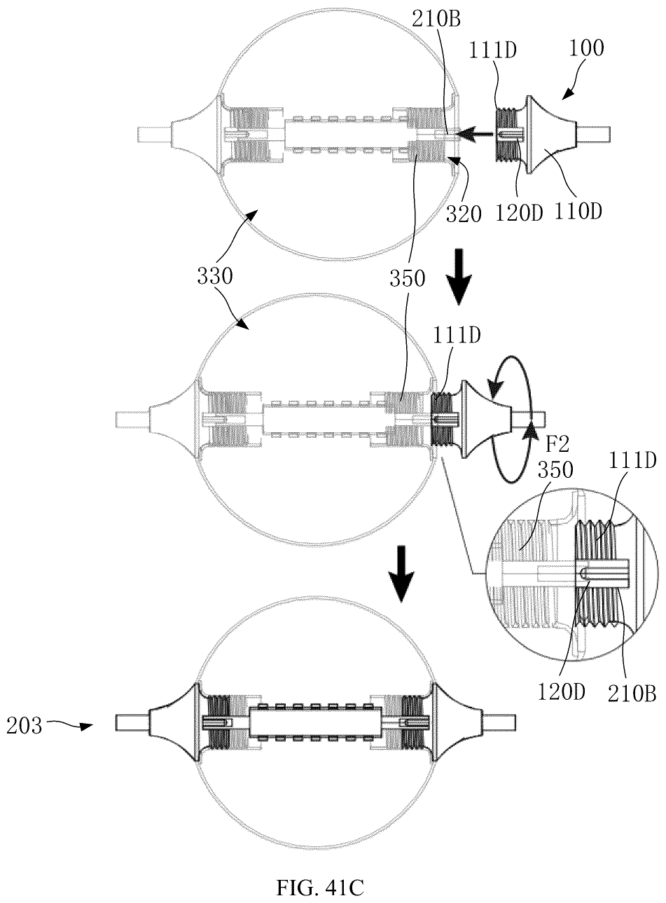

Specifically, as shown in FIG. 41A, the first power connecting port 120C of the first wiring terminal 100 is aligned with the first power connecting plug 210A of the light-emitting body 200, then the first power connecting port 120C of the first wiring terminal 100 and the first power connecting plug 210A of the light-emitting body 200 are plugged into each other but are not completely connected to define a gap 2011, thereby obtaining a first assembling body 201. The first power connecting port 120C and the first power connecting plug 210A mutually rotate, rotate relative to each other, or rotate together during the mutual plugging process. After the first power connecting port 120C is connected to the first power connecting plug 210A to define the gap 2011, the first power connecting port 120C and the first power connecting plug 210A mutually rotate, rotate relative to each other, or rotate together.

The step S32 comprises connecting the first wiring terminal 100 to the lampshade 300.

Specifically, as shown in FIG. 41B, the second power connecting plug 210B of the light-emitting body 200 is aligned with the first opening 310 of the lampshade 300. Then, the second power connecting plug 210B of the light-emitting body 200, the one or more light-emitting elements and a portion of the first power connecting plug 210A are inserted into the accommodating cavity 330 until the first terminal body 110C of the first wiring terminal 100 contacts the lampshade 300. The first terminal body 110C is driven to rotate relative to the lampshade 300 along the first direction F1 to connect the first outer thread 111C of the first terminal body 110C with the first inner thread 340 of the lampshade 300 until the first outer thread 111C is completely screwed with the first inner thread 340, thereby obtaining a second assembling body 202. During the connection process of the first outer thread 111C of the first terminal body 110C and the first inner thread 340 of the lampshade 300 (in other words, the process of the first terminal body 110C rotating relative to the lampshade 300 along the first direction F1), the first terminal body 110C, the first power connecting port 120C, and the light-emitting body 200 rotate together.

In the second assembling body 102, at least a portion of the second power connecting plug 210B is located at the second opening 320. In some cases, a portion of the second power connecting plug 210B extends from the second opening 320 to the outside of the lampshade 300. In other cases, one end of the second power connecting plug 210B away from the one or more light-emitting elements is flush with an edge of the lampshade 300.

The step S23 comprises physically connecting the second wiring terminal 100 to the lampshade 300 to enable the second wiring terminal 100 being electrically connected to the light-emitting body 200.

Specifically, as shown in FIG. 41C, the second power connecting port 120D of the second wiring terminal 100 is aligned with the second power connecting plug 210B located at the second opening 320 of the lampshade 300, and the second terminal body 110D of the second wiring terminal 100 is also aligned with the second opening 320 of the lampshade 300. Then, the second outer thread 111D of the second terminal body 110D of the second wiring terminal 100 is connected to the second inner thread 350 of the lampshade 300. At the same time, the second power connecting port 120D of the second wiring terminal 100 is plugged into the second power connecting plug 210B of the light-emitting body 200 from the second opening 320. Finally, the second terminal body 110D is driven to rotate relative to the lampshade 300 in a second direction F2 to completely connect the second outer thread 111D of the second terminal body 110D with the second inner thread 350 of the lampshade 300. At the same time, the first power connecting plug 210C and the first power connecting port 120C are driven to continue to be plugged into each other without the gap 2011, so that the at least two electrical connectors of the first power connecting port 120C are correspondingly connected to the at least two electrical connectors of the first power connecting plug 210A, and the at least two electrical connectors of the second power connecting port 120D are electrically connected to the at least two electrical connectors of the second power connecting plug 210D, thereby obtaining a third assembling body 203. The third assembling body 203 is a completely structure in which the two wiring terminals 100, the light-emitting body 200 and the lampshade 300 are assembled together.

In the embodiment, during the connection process between the second outer thread 111D of the second terminal body 110D of the second wiring terminal 100 and the second inner thread 350 of the lampshade 300, the second power connecting port 120D of the second wiring terminal 100 and the light-emitting body 200 mutually rotate, rotate relative to each other, or rotate together. After the second outer thread 111D of the second terminal body 110D of the second wiring terminal 100 is completely screwed with the second inner thread 350 of the lampshade 300, the at least two electrical connectors of the first power connecting port 120C of the first wiring terminal 100 and the at least two electrical connectors of the second power connecting port 120D of the second wiring terminal 100 are electrically connected to the light-emitting body 200 to form the electrical circuit.

In other optional embodiments, each light-emitting body and the corresponding wiring terminal are processed together in advance. The present disclosure hereby takes one light-emitting body and one wiring terminal as an example for further illustration. Specifically, the wiring terminal comprises the at least two electrical connectors. The light-emitting body of the embodiment comprises the flexible circuit board and the one or more light-emitting elements disposed on the flexible circuit board. The at least two electrical connectors of the wiring terminal are electrically connected to the flexible circuit board, and the at least two electrical connectors of the wiring terminal and the flexible circuit board are directly welded or connected by wires. The flexible circuit board is physically connected to the wiring terminal, which means that the non-luminous surface of the flexible circuit board is disposed on a portion of the outer surface of the wiring terminal. The at least two electrical connectors of the wiring terminal are electrically connected to the control component of the lamp through a wire, and the control component can be disposed at a desired position according to requirements, such as in the base. In the actual mounting process of the wiring terminal and the lampshade, the portion of the wiring terminal with the flexible circuit board is inserted into the accommodating cavity of the lampshade from any opening of the lampshade. Compared with the embodiment in which the wiring terminal and the light-emitting body are plugged into each other to realize connection, the embodiment reduces the composition of the light-emitting body, thereby reducing processing steps of the light-emitting body, facilitating the connection between the light-emitting body and the wiring terminal, and facilitating the physical connection between the wiring terminal and the lampshade.

Furthermore, one embodiment of the present disclosure further provides a wiring terminal module, the wiring terminal module at least one wiring terminal, and the at least one wiring terminal in the wiring terminal module may refer to the wiring terminal (100A-I), which is not described in detail herein. It should be noted that when the wiring terminal module comprises two wiring terminals, the two wiring terminals are connected to different positions of the same lampshade. For example, the wiring terminal module comprises two wiring terminals 100 shown in FIG. 29D. Alternatively, the wiring terminal module comprises two wiring terminals 100 shown in FIG. 40C. Alternatively, the wiring terminal module comprises two wiring terminals 100 shown in FIG. 41C. It should also be noted that the number of the wiring terminals of the wiring terminal module may be other numbers, which is not limited thereto.

What is claimed is:

1. A wiring terminal of a lamp, comprising:
at least one terminal body; and
at least one power connecting port;
wherein an outer thread is disposed on an outer side surface of the at least one terminal body, the outer thread of the at least one terminal body is rotatable around a first axis, and the outer thread of the at least one terminal body is configured to be screwed with an inner thread disposed on at least one opening of a lampshade of the lamp;
wherein the at least one power connecting port comprises at least two electrical connectors, the at least two connectors of the at least one power connecting port are rotatable around a second axis, and the second axis overlaps or is parallel to the first axis;
wherein the at least one terminal body and the at least one power connecting port are capable of rotating together.

2. The wiring terminal according to claim 1, wherein the at least two electrical connectors of the at least one power connecting port extend along the second axis, and at least portions of the at least two electrical connectors of the at least one power connecting port are disposed in a direction perpendicular to the second axis.

3. The wiring terminal according to claim 1, wherein the at least two electrical connectors of the at least one power connecting port have different extension lengths along the second axis, the at least two power connectors of the at least one power connecting port are sequentially disposed along the second axis; or
the at least two electrical connectors of the at least one power connecting port have different extension lengths along the second axis, and the at least two electrical connectors of the at least one power connecting port are disposed in a direction perpendicular to the second axis; or
the at least two electrical connectors of the at least one power connecting port have a same extension length along the second axis, and the at least two electrical connectors of the at least one power connecting port are disposed in the direction perpendicular to the second axis; or
a first electrical connector of the at least one power connecting port is disposed around a second electrical connector of the at least one power connecting port.

4. The wiring terminal according to claim 1, wherein the at least one terminal body comprises a first terminal body and a second terminal body, the at least one power connecting port comprises a first power connecting port and a second power connecting port, the first power connecting port and the second power connecting port are connected through wires, and the second terminal body and the first terminal body are directly connected or spaced apart;
wherein the first terminal body is connected to the first power connecting port, the first terminal body and the first power connecting port are allowed to rotate together, the first terminal body is rotatable around the first axis, and the first power connecting port is rotatable around the second axis;
wherein the second terminal body is connected to the second power connecting port, and the second terminal body and the second power connecting port are rotatable together.

5. The wiring terminal according to claim 1, wherein the at least one power connecting port is connected to the at least one terminal body, and a connecting manner thereof is selected from a connecting manner A, a connecting manner B, a connecting manner C, and a connecting manner D;
wherein in the connecting manner A, at least portions of the at least two electrical connectors of the at least one power connecting port protrude from an end surface of the at least one terminal body along the first axis, the at least two electrical connectors of the at least one power connecting port are able to be placed into the lampshade at least from a first opening of the lampshade of the lamp, and the at least two electrical connectors of the at least one power connecting port are able to be taken out from the first opening of the lampshade of the lamp;
wherein in the connecting manner B, the at least two electrical connectors of the at least one power connecting port are disposed on the end surface of the at least one terminal body, a protective sleeve is disposed on the end surface of the at least one terminal body, and the protective sleeve is disposed around the at least two electrical connectors of the at least one power connecting port;
wherein in the connecting manner C, one end of the at least one terminal body is recessed to define a receiving groove along the first axis, and the at least two electrical connectors of the at least one power connecting port are disposed in the receiving groove and do not exceed the end surface of the at least one terminal body;
wherein in the connecting manner D, the at least two electrical connectors of the at least one power connecting port are movable on the at least one terminal body along the first axis to be accommodated in or extended out of the one end of the at least one terminal body.

6. The wiring terminal according to claim 1, wherein an end surface of the at least one terminal body away from the at least one power connecting port is recessed to form at least two clamping grooves, the at least two clamping grooves are spaced apart from each other, and the at least two clamping grooves are configured for plugging a tool to drive the at least one terminal body to rotate.

7. A wiring terminal module of a lamp, comprising: at least one wiring terminal;
wherein the at least one wiring terminal comprises at least one terminal body and at least one power connecting port connected to the at least one terminal body;
wherein an outer thread is disposed on an outer side surface of the at least one terminal body, and the outer thread of the at least one terminal body is configured to be screwed with an inner thread disposed on at least one opening of a lampshade of the lamp;
wherein the at least one power connecting port comprises at least two electrical connectors, the at least two connectors of the at least one power connecting port are configured to be connected to an electrical component of the lamp, and the at least one terminal body and the at least one power connecting port are rotatable together;
wherein during a connection process of the outer thread of the at least one terminal body and the inner thread of the at least one opening of the lampshade, the at least one power connecting port and the electrical component are plugged into each other, and the at least one power connecting port and the electrical component mutually rotate, rotate relative to each other, or rotate together;
wherein after the outer thread of the at least one terminal body is completely screwed with the first inner thread of the lampshade, the at least two electrical connectors of the at least one power connecting port are electrically connected to the electrical component of the lamp.

8. The wiring terminal module according to claim 7, wherein the at least one wiring terminal comprises a first wiring terminal and a second wiring terminal, and the at least one opening comprises a first opening and a second opening;
wherein the first wiring terminal comprises a first terminal body and a first power connecting port connected to the first terminal body, and the second wiring terminal comprises a second terminal body and a second power connecting port connected to the second terminal body;
wherein during an assembling process of the lamp, the first terminal body is connected to the lampshade of the lamp before the second terminal body is connected to the lampshade, and the first terminal body is electrically connected to the electrical component of the lamp before the second terminal body is electrically connected to the electrical component of the lamp;
during a connection process of a first outer thread of the first terminal body and a first inner thread of the first opening of the lampshade, a first power connecting port of the first terminal body rotates together with the electrical component of the lamp;
during a connection process of a second outer thread of the second terminal body and a second inner thread of the second opening of the lampshade, a second power connecting port of the second terminal body and the electrical component of the lamp mutually rotate, rotate relative to each other, or rotate together; and
after the second outer thread of the second terminal body is completely screwed with the second inner thread of the lampshade, the at least two electrical connectors of the first power connecting port and the at least two electrical connectors of the second power connecting port are electrically connected to the electrical component of the lamp.

9. The wiring terminal module according to claim 7, wherein the at least one wiring terminal comprises a first wiring terminal and a second wiring terminal, and the at least one opening comprises a first opening and a second opening;
wherein the first wiring terminal comprises a first terminal body and a first power connecting port connected to the first terminal body, and the second wiring terminal comprises a second terminal body and a second power connecting port connected to the second terminal body;
wherein during an assembling process of the lamp, the second terminal body is connected to the lampshade of the lamp before the first terminal body is connected to the lampshade, and the first terminal body is electrically connected to the electrical component of the lamp before the second terminal body is electrically connected to the electrical component of the lamp;
during a connection process of a first outer thread of the first terminal body and a first inner thread of the first opening of the lampshade, a first power connecting port of the first terminal body rotates together with the electrical component of the lamp, and a second power connecting port of the second terminal body and the electrical component of the lamp mutually rotate, rotate relative to each other, or rotate together; and
when the first outer thread of the first terminal body is completely screwed with the first inner thread of the lampshade, the at least two electrical connectors of the first power connecting port and the at least two electrical connectors of the second power connecting port are electrically connected to the electrical component of the lamp.

10. A light-emitting body of a lamp, comprising:
one or more light-emitting elements;
a rigid circuit board electrically connected to the one or more light-emitting elements; and
at least one power connecting plug fixed to and electrically connected to the rigid circuit board;
wherein the at least one power connecting plug comprises at least two electrical connectors, the at least two electrical connectors of the at least one power connecting plug are rotatable around a third axis, and the at least one power connecting plug is configured to be plugged into at least one power connecting port of the lamp, so that the at least two electrical connectors of the at least one power connecting plug are electrically connected to at least two electrical connectors of the at least one power connecting port of the lamp.

11. The light-emitting body according to claim 10, wherein the light-emitting body further comprises a flexible circuit board, the one or more light-emitting elements are electrically connected to the rigid circuit board through the flexible circuit board, and the flexible circuit board is disposed around the rigid circuit board; or
the one or more light-emitting elements are directly disposed on at least one side of the rigid circuit board.

12. The light-emitting body according to claim 10, wherein the one or more light-emitting elements are directly disposed on at least one side of the rigid circuit board, the light-emitting body further comprises an outer sleeve, the outer sleeve is disposed around the rigid circuit board to cover the one or more light-emitting elements, and the outer sleeve is light-transmissive so that light emitted by the one or more light-emitting elements is able to penetrate through the outer sleeve.

13. The light-emitting body according to claim 10, wherein the at least one power connecting plug comprises a first power connecting plug and a second power connecting plug;
wherein the first power connecting plug and the second power connecting plug are fixed to the rigid circuit board and are electrically connected to the rigid circuit board, the at least two electrical connectors of the first power connecting plug are rotatable around the third axis, and the at least two electrical connectors of the second power connecting plug are rotatable around a fourth axis.

14. The light-emitting body according to claim 13, wherein the third axis is coaxial with the fourth axis.

15. The light-emitting body according to claim 13, wherein the first power connecting plug and the second power connecting plug are symmetrically disposed relative to the rigid circuit board; or
an angle between the first power connecting plug and the second power connecting plug is greater than 0 degrees and less than 180 degrees.

16. The light-emitting body according to claim 13, wherein the light-emitting body further comprises a support, the support is sleeved on the rigid circuit board, the support is configured to support the flexible circuit board, and a non-luminous surface of the flexible circuit board is disposed on an outer surface of the support.

17. A lamp, comprising:
a lampshade;
at least one wiring terminal; and
a light-emitting body;
wherein the lampshade comprises an accommodating cavity and a first opening communicated with the accommodating cavity, and a first inner thread is disposed on the first opening;
wherein the at least one wiring terminal comprises at least one terminal body and at least one power connecting port, an outer thread is disposed on an outer side surface of the at least one terminal body, the outer thread of the at least one terminal body is rotatable around a first axis, the outer thread of the at least one terminal body is screwed with the first inner thread;
and the at least one power connecting port comprises at least two electrical connectors;
wherein the light-emitting body is capable of being placed into the accommodating cavity through the first opening and is capable of being taken out of the accommodating cavity through the first opening, the light-emitting body comprises one or more light-emitting elements, a rigid circuit board, and at least one power connecting plug, wherein the one or more light-emitting elements are electrically connected to the rigid circuit board, and light emitted by the one or more light-emitting elements is capable of penetrating through the lampshade, the at least one power connecting plug is fixed to and electrically connected to the rigid circuit board, and the at least one power connecting plug comprises at least two electrical connectors;
wherein the at least one power connecting plug is detachably connected to the at least one wiring terminal, and when the at least one power connecting plug and the at least one wiring terminal are plugged into each other, the at least two electrical connectors of the at least one power connecting plug are electrically connected to the at least two electrical connectors of the at least one power connecting port;
wherein the at least two electrical connectors of the at least one power connecting port are rotatable around a second axis; and/or the at least two electrical connectors of the at least one power connecting plug are rotatable around a third axis;
wherein at least one of the second axis and the third axis overlaps or is parallel to the first axis.

18. The lamp according to claim 17, wherein the light-emitting body further comprises a flexible circuit board, the one or more light-emitting elements are electrically connected to the rigid circuit board through the flexible circuit board, and the flexible circuit board is disposed around the rigid circuit board.

19. The lamp according to claim 17, wherein during a connection process of the at least one power connecting plug and the at least one power connecting port and/or after the at least one power connecting plug and the at least one power connecting port are plugged into each other, the at least one power connecting plug and the at least one power connecting port mutually rotate, rotate relative to each other, or rotate together; and/or,
during a connection process of the outer thread of the at least one terminal body and the first inner thread, the at least one terminal body and the lampshade mutually rotate or rotate relative to each other,, the at least one power connecting plug and the at least one power connecting port are plugged into each other, and the at least one power connecting plug and the at least one power connecting port mutually rotate, rotate relative to each other, or rotate together; and/or,
after the outer thread of the at least one terminal body is completely screwed with the first inner thread, the at least one terminal body seals the first opening, and the at least two electrical connectors of the at least one power connecting port are electrically connected to the at least two electrical connectors of the at least one power connecting plug; and/or,
the at least one terminal body and the at least one power connecting port are rotatable together around the first axis.

20. The lamp according to claim 17, wherein the outer thread of the at least one terminal body, the first inner thread, the at least two electrical connectors of the at least one power connecting plug, and the at least two electrical connectors of the at least one power connecting port are rotatable around the first axis.

21. The lamp according to claim 17, wherein the lampshade comprises a second opening, a second inner thread is disposed on the second opening, the at least one wiring terminal comprises a first wiring terminal and a second wiring terminal, the first wiring terminal is screwed with the first opening, and the second inner thread of the second opening is screwed with the outer thread of the second wiring terminal; or
the lamp further comprises a solar panel, the solar panel is disposed on the lampshade, and the at least one power connecting plug comprises a first power connecting plug and a second power connecting plug, the first power connecting plug is connected to the at least one wiring terminal, the second power connecting plug is fixed to and electrically connected to the rigid circuit board, and the second power connecting plug is electrically connected to the solar panel; or
wherein the lampshade is closed at a position opposite to the first opening.
